(19) United States
(12) Patent Application Publication
(10) Pub. No.: US 2026/0074724 A1
(43) Pub. Date: Mar. 12, 2026

(54) DISTORTION SUPPRESSION IN RADIO FREQUENCY SIGNAL GENERATORS

(71) Applicant: International Business Machines Corporation, Armonk, NY (US)

(72) Inventor: Sudipto Chakraborty, Plano, TX (US)

(21) Appl. No.: 18/813,291

(22) Filed: Aug. 23, 2024

(51) Int. Cl. H04B 1/04; H04L 25/03

(52) U.S. Cl. CPC H04B 1/0483; H04B 1/0458; H04L 25/03

(57) ABSTRACT

A device comprises a radio frequency signal generator. The radio frequency signal generator comprises a plurality of signal paths, and a signal combiner. The plurality of signal paths are configured to operate in parallel to convert a baseband signal to a plurality of radio frequency signals, wherein each signal path of the plurality of signal paths outputs a respective one of the plurality of radio frequency signals. The signal combiner is configured to combine the plurality of radio frequency signals to cancel corresponding distortion components in the plurality of radio frequency signals, and output a resulting radio frequency output signal with at least one suppressed distortion component.

### BACKGROUND

This disclosure relates generally to radio frequency (RF) signal generators and, in particular, to techniques for suppressing signal distortion in RF signal generators such as arbitrary waveform generator (AWG) systems. In general, RF signal generators are utilized for applications such as, e.g., wireless transmitters, and generating control pulses for quantum bits (qubits) in a quantum computing system, etc. In particular, in quantum computing applications, AWG systems are utilized to generate RF control pulses with desired frequencies and pulse shapes to control quantum devices, such as quantum bits (qubits), of a quantum processor. In addition, minimizing power consumption of an AWG system is of critical importance, especially in the context of cryogenic RF signal generation for qubit control.

Typically, baseband input stages of an RF signal generator introduce nonlinearities in the baseband signal paths, which create harmonic distortion terms (e.g., odd harmonics of a fundamental frequency) in the RF signal paths, which are undesirable. However, reducing such odd order distortion terms requires significantly high levels of current consumption (and thus high-power consumption) to achieve, e.g., a desired spurious-free dynamic range (SFDR) greater than 60 dB for next generation quantum computing systems. Such high-power consumption is prohibitive for various applications such as cryogenic applications for superconducting quantum computing, as higher power increases the thermal load on a cryostat or dilution refrigerator.

### SUMMARY

Exemplary embodiments of the disclosure include techniques for suppressing signal distortion in RF signal generators such as arbitrary waveform generator systems.

An exemplary embodiment includes a device which comprises a radio frequency signal generator. The radio frequency signal generator comprises a plurality of signal paths, and a signal combiner. The plurality of signal paths are configured to operate in parallel to convert a baseband signal to a plurality of radio frequency signals, wherein each signal path of the plurality of signal paths outputs a respective one of the plurality of radio frequency signals. The signal combiner is configured to combine the plurality of radio frequency signals to cancel corresponding distortion components in the plurality of radio frequency signals, and output a resulting radio frequency output signal with at least one suppressed distortion component.

Another exemplary embodiment includes a system which comprises a quantum processor, and an arbitrary waveform generator. The quantum processor comprises at least one quantum bit. The arbitrary waveform generator comprises at least one arbitrary waveform generator channel that is configured to convert a baseband signal to a radio frequency control signal which controls the at least one quantum bit. The at least one arbitrary waveform generator channel comprises a plurality of signal paths, and a signal combiner. The plurality of signal paths are configured to operate in parallel to convert the baseband signal to a plurality of radio frequency signals, wherein each signal path of the plurality of signal paths outputs a respective one of the plurality of radio frequency signals. The signal combiner is configured to combine the plurality of radio frequency signals to cancel corresponding distortion components in the plurality of radio frequency signals, and output a resulting radio frequency output signal as the radio frequency control signal, which comprises at least one suppressed distortion component.

Another exemplary embodiment includes a device which comprises a radio frequency signal generator. The radio frequency signal generator comprises a first signal path, a second signal path, and a signal combiner. The first signal path and the second signal path arc configured to operate in parallel to convert a baseband signal to a first radio frequency signal which is output from the first signal path, and a second radio frequency signal which is output from the second signal path. The signal combiner is configured to combine the first radio frequency signal and the second radio frequency signal to cancel corresponding third-order harmonic frequency components of a baseband signal frequency in the first radio frequency signal and the second radio frequency signal, and output a resulting radio frequency output signal in which the third-order harmonic frequency component of the baseband signal frequency is substantially suppressed.

Another exemplary embodiment includes a method which comprises: converting a baseband signal to a radio frequency signal using a plurality of signal paths which operate in parallel to convert the baseband signal to a plurality of radio frequency signals, wherein each signal path of the plurality of signal paths outputs a respective one of the plurality of radio frequency signals; and combining the plurality of radio frequency signals to cancel corresponding distortion components in the plurality of radio frequency signals, and output a resulting radio frequency output signal with at least one suppressed distortion component.

Another exemplary embodiment includes a method which comprises calibrating a radio frequency signal generator to convert a baseband signal to a radio frequency control signal, wherein calibrating the radio frequency signal generator comprises: calibrating a first signal path of the radio frequency signal generator to operate with a first current density; operating the first signal path to convert the baseband signal to a first radio frequency signal; analyzing the first radio frequency signal to determine a signal level of a target harmonic component in the first radio frequency signal; calibrating a second signal path of the radio frequency signal generator to operate with a second current density, which is less than the first current density; operating the second signal path to convert the baseband signal to a second radio frequency signal; analyzing the second radio frequency signal to determine a signal level of the target harmonic component in the second radio frequency signal; determining a difference between the signal levels of the target harmonic components in the first radio frequency signal and the second radio frequency signal; and in response to determining that the difference between the signal levels of the target harmonic components in the first radio frequency signal and the second radio frequency signal exceed a specified threshold, recalibrating a second signal path of the radio frequency signal generator to adjust the second current density to equalize signal levels of the target harmonic components in the first radio frequency signal and the second radio frequency signal.

Other embodiments will be described in the following detailed description of exemplary embodiments, which is to be read in conjunction with the accompanying figures.

### BRIEF DESCRIPTION OF THE DRAWINGS

FIG. 1 schematically illustrates a radio frequency signal generator system which is configured to generate radio frequency signals with suppressed harmonic distortion, according to an exemplary embodiment of the disclosure.

FIG. 2A schematically illustrates a radio frequency signal generator system which is configured to generate radio frequency signals with suppressed harmonic distortion, according to another exemplary embodiment of the disclosure.

FIG. 2B schematically illustrates a radio frequency signal generator system which is configured to generate radio frequency signals with suppressed harmonic distortion, according to another exemplary embodiment of the disclosure.

FIG. 3A schematically illustrates a method of utilizing multiple parallel RF paths of an RF signal generator to achieve harmonic distortion suppression, according to an exemplary embodiment of the disclosure.

FIG. 3B schematically illustrates a method of utilizing multiple parallel RF paths of an RF signal generator to achieve harmonic distortion suppression, according to another exemplary embodiment of the disclosure.

FIG. 4 schematically illustrates a radio frequency signal generator system which is configured to generate radio frequency signals with suppressed harmonic distortion, according to another exemplary embodiment of the disclosure.

FIG. 5 schematically illustrates a radio frequency signal generator system which is configured to generate radio frequency signals with suppressed harmonic distortion, according to another exemplary embodiment of the disclosure.

FIG. 6 schematically illustrates a circuit which can be utilized to implement a baseband input stage of an RF signal generator, according to an exemplary embodiment of the disclosure.

FIG. 7 schematically illustrates a circuit which can be utilized to implement a baseband input stage of an RF signal generator, according to another exemplary embodiment of the disclosure.

FIGS. 8A and 8B schematically illustrate a radio frequency signal generator system which is configured to generate radio frequency signals with suppressed harmonic distortion, according to another exemplary embodiment of the disclosure.

FIG. 9 illustrates a flow diagram of a method to perform distortion calibration in radio frequency signal generator to suppress harmonic distortion, according to another exemplary embodiment of the disclosure.

FIG. 10 schematically illustrates a quantum computing system which implements an arbitrary waveform generator system that is configured to generate radio frequency signals with suppressed harmonic distortion, according to an exemplary embodiment of the disclosure.

FIG. 11 schematically illustrates a quantum computing system, according to another exemplary embodiment of the disclosure.

FIG. 12 schematically illustrates an exemplary computing environment which is configured to execute program instructions for performing quantum computing operations and harmonic distortion calibration operations, according to an exemplary embodiment of the disclosure.

### DETAILED DESCRIPTION

Exemplary embodiments of the disclosure will now be described in further detail with regard to techniques for suppressing signal distortion in RF signal generators such as arbitrary waveform generator systems.

For example, an exemplary embodiment includes a device which comprises a radio frequency signal generator. The radio frequency signal generator comprises a plurality of signal paths, and a signal combiner. The plurality of signal paths are configured to operate in parallel to convert a baseband signal to a plurality of radio frequency signals, wherein each signal path of the plurality of signal paths outputs a respective one of the plurality of radio frequency signals. The signal combiner is configured to combine the plurality of radio frequency signals to cancel corresponding distortion components in the plurality of radio frequency signals, and output a resulting radio frequency output signal with at least one suppressed distortion component.

Another exemplary embodiment includes a system which comprises a quantum processor, and an arbitrary waveform generator. The quantum processor comprises at least one quantum bit. The arbitrary waveform generator comprises at least one arbitrary waveform generator channel that is configured to convert a baseband signal to a radio frequency control signal which controls the at least one quantum bit. The at least one arbitrary waveform generator channel comprises a plurality of signal paths, and a signal combiner. The plurality of signal paths are configured to operate in parallel to convert the baseband signal to a plurality of radio frequency signals, wherein each signal path of the plurality of signal paths outputs a respective one of the plurality of radio frequency signals. The signal combiner is configured to combine the plurality of radio frequency signals to cancel corresponding distortion components in the plurality of radio frequency signals, and output a resulting radio frequency output signal as the radio frequency control signal, which comprises at least one suppressed distortion component.

In another exemplary embodiment, which may be combined with one or more of the embodiments of the preceding paragraphs, the plurality of signal paths comprises a first signal path and a second signal path. The first signal path converts the baseband signal to a first radio frequency signal. The second signal path converts the baseband signal to a second radio frequency signal. The corresponding distortion components in the first radio frequency signal and the second radio frequency signal comprise at least one odd-order harmonic component of a baseband frequency of the baseband signal, which is present in both the first radio frequency signal and the second radio frequency signal.

In another exemplary embodiment, which may be combined with one or more of the embodiments of the preceding paragraphs, each signal path of the plurality of signal paths comprises a baseband input stage, a mixer stage coupled to an output of the baseband input stage, and a gain adjust stage coupled to an output of the mixer stage.

In another exemplary embodiment, which may be combined with one or more of the embodiments of the preceding paragraphs, The baseband input stage of the first signal path is configured to have a first type of nonlinearity, and the baseband input stage of the second signal path is configured to have a second type of nonlinearity, which is different from the first type of nonlinearity.

In another exemplary embodiment, which may be combined with one or more of the embodiments of the preceding paragraphs, the first type of nonlinearity comprises expansive nonlinearity, and the second type of nonlinearity comprises compressive nonlinearity.

In another exemplary embodiment, which may be combined with one or more of the embodiments of the preceding paragraphs, the baseband input stage of the first signal path and the baseband input stage of the second signal path are each configured to have a same type of nonlinearity, where the same type of nonlinearity comprises a compressive nonlinearity or an expansive nonlinearity.

In another exemplary embodiment, which may be combined with one or more of the embodiments of the preceding paragraphs, the first signal path is configured to operate with a first current density. The second signal path is configured to operate with a second current density, which is less than the first current density. The first current density and the second current density are calibrated so that the corresponding distortion components in the first radio frequency signal and the second radio frequency signal have a same signal level.

In another exemplary embodiment, which may be combined with one or more of the embodiments of the preceding paragraphs, the second signal path is configured to operate with phase delay to cause a phase alignment of the corresponding distortion components in the first radio frequency signal and the second radio frequency signal.

In another exemplary embodiment, which may be combined with one or more of the embodiments of the preceding paragraphs, a phase adjustment circuit is configured to apply a phase delay to a local oscillator signal that is applied to a mixer stage in the second signal path to cause the phase delay.

In another exemplary embodiment, which may be combined with one or more of the embodiments of the preceding paragraphs, the plurality of signal paths further comprise a third signal path to convert the baseband signal to a third radio frequency signal which is output from the third signal path, where the corresponding distortion components in the first radio frequency signal, the second radio frequency signal, and the third radio frequency signal each comprise at least two odd-order harmonic components of the baseband frequency of the baseband signal. The signal combiner is configured to combine the first radio frequency signal, the second radio frequency signal, and the third radio frequency signal to cancel corresponding odd-order harmonic components of the baseband signal frequency, which are present in the first radio frequency signal, the second radio frequency signal, and the third radio frequency signal, and output the resulting radio frequency output signal with at least two suppressed odd-order harmonic components.

Another exemplary embodiment includes a device which comprises a radio frequency signal generator. The radio frequency signal generator comprises a first signal path, a second signal path, and a signal combiner. The first signal path and the second signal path are configured to operate in parallel to convert a baseband signal to a first radio frequency signal which is output from the first signal path, and a second radio frequency signal which is output from the second signal path. The signal combiner is configured to combine the first radio frequency signal and the second radio frequency signal to cancel corresponding third-order harmonic frequency components of a baseband signal frequency in the first radio frequency signal and the second radio frequency signal, and output a resulting radio frequency output signal in which the third-order harmonic frequency component of the baseband signal frequency is substantially suppressed.

In another exemplary embodiment, which may be combined with one or more of the embodiments of the preceding paragraphs, the radio frequency signal generator further comprises a third signal path, which is configured to operate in parallel with the first signal path and the second signal path, to convert the baseband signal to a third radio frequency signal which is output from the third signal path. The signal combiner is configured to combine the first radio frequency signal, the second radio frequency signal, and the third radio frequency signal to cancel the corresponding third-order harmonic frequency components of the baseband signal frequency and corresponding fifth-order harmonic frequency components of the baseband signal frequency, which are present in the first radio frequency signal, the second radio frequency signal, and the third radio frequency signal, and output a resulting radio frequency output signal in which the third-order harmonic frequency component and the fifth-order harmonic frequency component are substantially suppressed.

Another exemplary embodiment includes a method to generate a radio frequency signal. A baseband signal is converted to a radio frequency signal using a plurality of signal paths which operate in parallel to convert the baseband signal to a plurality of radio frequency signals, where each signal path of the plurality of signal paths outputs a respective one of the plurality of radio frequency signals. The plurality of radio frequency signals are combined to cancel corresponding distortion components in the plurality of radio frequency signals, and output a resulting radio frequency output signal with at least one suppressed distortion component.

In another exemplary embodiment, which may be combined with one or more of the embodiments of the preceding paragraphs, the method comprises configuring a first signal path of the plurality of signal paths to operate with a first current density and output a first radio frequency signal of the plurality of radio frequency signals, and configuring a second signal path of the plurality of signal paths to operate with a second current density, which is less than the first current density, and output a second radio frequency signal of the plurality of radio frequency signals. The first current density and the second current density are calibrated so that the corresponding distortion components in the first radio frequency signal and the second radio frequency signal have a same signal level.

In another exemplary embodiment, which may be combined with one or more of the embodiments of the preceding paragraphs, the method further comprises configuring the second signal path to operate with phase delay to cause a phase alignment of the corresponding distortion components in the first radio frequency signal and the second radio frequency signal.

Another exemplary embodiment includes a method which comprises calibrating a radio frequency signal generator to convert a baseband signal to a radio frequency control signal, where calibrating the radio frequency generator comprises the following. A first signal path of the radio frequency signal generator is calibrated to operate with a first current density. The first signal path is operated to convert the baseband signal to a first radio frequency signal. The first radio frequency signal is analyzed to determine a signal level of a target harmonic component in the first radio frequency signal. A second signal path of the radio frequency signal generator is calibrated to operate with a second current density, which is less than the first current density. The second signal path is operated to convert the baseband signal to a second radio frequency signal. The second radio frequency signal is analyzed to determine a signal level of the target harmonic component in the second radio frequency signal. A difference is determined between the signal levels of the target harmonic components in the first radio frequency signal and the second radio frequency signal. In response to determining that the difference between the signal levels of the target harmonic components in the first radio frequency signal and the second radio frequency signal exceeds a specified threshold, the second signal path of the radio frequency signal generator is recalibrated to adjust the second current density to equalize signal levels of the target harmonic components in the first radio frequency signal and the second radio frequency signal.

In another exemplary embodiment, which may be combined with one or more of the embodiments of the preceding paragraphs, calibrating the first signal path of the radio frequency signal generator to operate with the first current density comprises calibrating the first current density to achieve a target signal level of a fundamental frequency component in the first radio frequency signal.

In another exemplary embodiment, which may be combined with one or more of the embodiments of the preceding paragraphs, calibrating the first signal path comprises adjusting a gain setting of a baseband input stage in the first signal path to set the first current density in the first signal path.

In another exemplary embodiment, which may be combined with one or more of the embodiments of the preceding paragraphs, calibrating the second signal path comprises adjusting a gain setting of a baseband input stage in the second signal path to set the second current density in the second signal path.

It is to be understood that the various features shown in the accompanying drawings are schematic illustrations that are not drawn to scale. Moreover, the same or similar reference numbers are used throughout the drawings to denote the same or similar features, elements, or structures, and thus, a detailed explanation of the same or similar features, elements, or structures will not be repeated for each of the drawings. Further, the term “exemplary” as used herein means “serving as an example, instance, or illustration.” Any embodiment or design described herein as “exemplary” is not to be construed as preferred or advantageous over other embodiments or designs.

Further, it is to be understood that the phrase “configured to” as used in conjunction with a circuit, structure, element, component, or the like, performing one or more functions or otherwise providing some functionality, is intended to encompass embodiments wherein the circuit, structure, element, component, or the like, is implemented in hardware, software, and/or combinations thereof, and in implementations that comprise hardware, wherein the hardware may comprise discrete circuit elements (e.g., transistors, inverters, etc.), superconducting elements such as superconducting quantum bits, programmable elements (e.g., application specific integrated circuit (ASIC) chips, field-programmable gate array (FPGA) chips, etc.), processing devices (e.g., central processing units (CPUs), graphics processing units (GPUs), etc.), one or more integrated circuits, and/or combinations thereof. Thus, by way of example only, when a circuit, structure, element, component, etc., is defined to be configured to provide a specific functionality, it is intended to cover, but not be limited to, embodiments where the circuit, structure, element, component, etc., is comprised of elements, processing devices, and/or integrated circuits that enable it to perform the specific functionality when in an operational state (e.g., connected or otherwise deployed in a system, powered on, receiving an input, and/or producing an output), as well as cover embodiments when the circuit, structure, element, component, etc., is in a non-operational state (e.g., not connected nor otherwise deployed in a system, not powered on, not receiving an input, and/or not producing an output) or in a partial operational state.

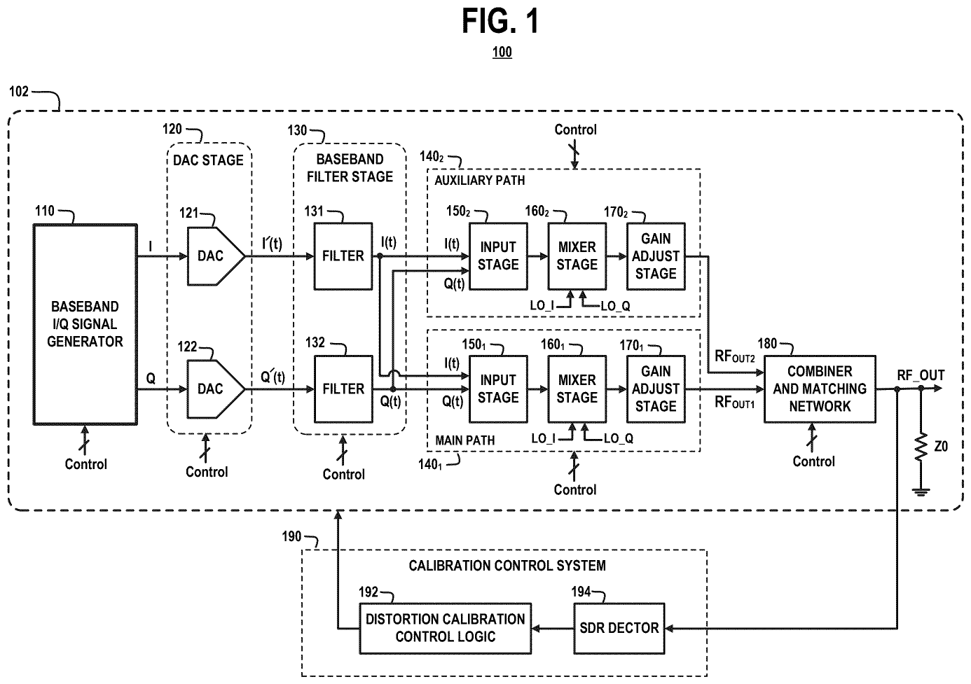

FIG. 1 schematically illustrates a radio frequency signal generator system which is configured to generate radio frequency signals with suppressed harmonic distortion, according to an exemplary embodiment of the disclosure. In particular, FIG. 1 schematically illustrates an RF signal generator system 100 which comprises an RF signal generator 102, wherein the RF signal generator 102 comprises a baseband I/Q signal generator 110, a digital-to-analog converter stage 120 (or DAC stage 120), a baseband filter stage 130, a first RF signal path 140₁ (alternatively, main path 140₁), a second RF signal path 140₂ (alternatively, auxiliary path 140₂), and a signal combiner and matching network 180. The main path 140₁ comprises a baseband input stage 150₁, a first mixer stage 160₁, and a first gain adjust stage 170₁. Similarly, the auxiliary path 140₂ comprises a baseband input stage 150₂, a mixer stage 160₂, and a gain adjust stage 170₂. The main path 140₁ and the auxiliary path 140₂ comprise RF signal generation paths that are coupled in parallel between an output of the baseband filter stage 130 and an input of the signal combiner and matching network 180.

In an exemplary RF signal generator architecture having only one RF signal path (e.g., only the first RF signal path 140₁), non-linearities of circuit blocks (e.g., a baseband filter stage and/or baseband input stage, can cause distortion in a resulting RF output signal waveform (RF_OUT). For example, the non-linearities of such circuit blocks can create odd-order distortion components (e.g., a third-order harmonic (3H) distortion component, a fifth-order harmonic (5H) distortion component, etc.) in the resulting RF output signal waveform, which is undesired for various applications. Such odd-order distortion terms can be suppressed by increasing the power consumption (e.g., increasing current consumption or current density) of the RF signal path to achieve a desired spurious-free dynamic range (SFDR) (e.g., SFDR>60 dB), where SFDR represents a strength ratio of a fundamental signal to the strongest spurious signal (e.g., strongest harmonic distortion component) in the RF output signal. However, as noted above, the implementation of an RF signal generator with high power consumption is prohibitive for, e.g., cryogenic applications due to limited cooling capability.

The exemplary architecture of the RF signal generator 102 shown in FIG. 1 implements multiple RF signal paths, which operate in parallel, to generate an RF output signal with significantly suppressed (or canceled) harmonic distortion components, and with low power consumption. In particular, the RF signal generator 102 comprises an exemplary architecture which implements two RF signal paths (e.g., the main path 140₁ and the auxiliary path 140₂) which operate in parallel to cancel or otherwise significantly suppress the third-order harmonic (3H) distortion component in the resulting RF output signal. As explained in further detail below, in some embodiments, suppression of the 3H distortion component (or 3H spur) is achieved by operating the main path 140₁ and the auxiliary path 140₂ in parallel at different power levels (e.g. using different current densities) to generate a first output signal (denoted RF_{OUT1}) from the main path 140₁, and generate a second output signal (denoted RF_{OUT2}) from the auxiliary path 140₂, wherein the first output signal and the second output signal each provide different ratios between a fundamental component and the 3H distortion components. The first output signal RF_{OUT1} and the second output signal RF_{OUT2} are combined (e.g., sum or difference) to cancel the 3H distortion components, such that the 3H distortion component in the resulting RF output signal RF_OUT is essentially canceled or significantly suppressed as compared to the resulting fundamental component of RF_OUT.

In some embodiments, the main path 140₁ and the auxiliary path 140₂ are configured differently in terms of power consumption, where the main path 140₁ is configured to utilize moderate current (moderate power consumption) and provide moderate distortion, while the auxiliary path 140₂ is configured to utilize low current (lower power consumption) and provide relatively high distortion, as compared to the main path 140₁. The signal levels of RF_{OUT1} and RF_{OUT2} are then scaled so that the 3H distortion components are the same or substantially the same so that they cancel each other. Moreover, the main path 140₁ and the auxiliary path 140₂ arc configured such that the two paths provide different levels of output current at the fundamental frequency, e.g., ˜20 dB difference, where the fundamental component of the output signal RF_{OUT1} from the main path 140₁ is substantially larger than the fundamental component of the output signal RF_{OUT2} from the auxiliary path 140₂. As such, the power level of the fundamental component in the resulting output signal RF_OUT is close to the power level of the fundamental component of the output signal RF_{OUT1} from the main path 140₁.

Moreover, the main path 140₁ and the auxiliary path 140₂ are configured to have respective current densities I₁ and I₂, where I₁>>I₂, but where I₁ is also relatively small. Advantageously, with an exemplary multi-path configuration of an RF signal generator, the one or more auxiliary paths allows the total current density of all RF signal paths, e.g., I₁+I₂, to be less than the current density I (e.g., I₁>>I₂) that would be needed in the main path 140₁ alone (e.g., without the auxiliary path 140₂) to achieve a same or similar signal-to-distortion ratio (SDR) or spurious-free dynamic range (SFDR) as would be achieved using the multi-path configuration. In this regard, a multi-path configuration of an RF signal generator can provide lower power consumption using multiple RF signal paths to cancel or suppress harmonic distortion, as compared to the power consumption of a RF signal generator which utilizes a single path (e.g., main path only) to achieve a similar level of harmonic distortion suppression.

The RF signal generator system 100 further comprises a calibration control system 190 which comprises distortion calibration control logic 192, and a signal-to-distortion ratio (SDR) detector 194. In general, the calibration control system 190 is configured to calibrate various stages of the RF signal generator 102 using digital control signals. In some embodiments, the calibration control system 190 is implemented using a combination of software (e.g., program execution), hardware (e.g., control logic and circuitry), and/or firmware, to implement various control functions, as described herein. In the context of signal distortion calibration, the calibration control system 190 utilizes the distortion calibration control logic 192, and the SDR detector 194 to calibrate operating parameters of various stages of the RF signal generator 102 to, e.g., optimize the suppression or cancellation of distortion components (e.g., suppress or cancel 3H spur) in the RF output signal RF_OUT, or otherwise achieve a desired SFDR.

In some embodiments, the SDR detector 194 comprises an RF spectrum analyzer that is configured to perform spectral analysis of an RF output signal RF_OUT, which is generated by the RF signal generator 102 at an output node thereof (e.g., at the output of the signal combiner and matching network 180), to assess the quality of the RF output signal. For example, in some embodiments, the SDR detector 194 is configured to detect power levels (in dB) of the fundamental and harmonic distortion components in the RF output signal, and compute metrics such as a signal-to-distortion ratio metric (SDR metric), and a spurious-free dynamic range (SFDR) metric, etc. In some embodiments, the SDR detector 194 comprises an off-chip RF spectrum analyzer, which is configured to perform RF spectral measurements and analysis in a room temperature environment. In other embodiments, the SDR detector 194 comprises an on-chip RF spectrum analyzer which is configured to perform RF spectral measurements and analysis in a cryogenic temperature environment.

The distortion calibration control logic 192 is configured to process RF spectral analysis measurements provided by the SDR detector 194 and perform a distortion calibration process to generate digital control signals, as needed, to adjust operating parameters of components of the main path 140₁ and/or components of the auxiliary path 140₂ to thereby achieve a target power level of fundamental component of the RF output signal, as well as eliminate or otherwise substantially suppress harmonic distortion component(s) of the RF output signal to achieve target SDR and/or SFDR metrics. For example, in some embodiments, corresponding distortion terms (e.g., 3H spurs) in RF_{OUT1} and RF_{OUT2} can be made equal or substantially equal by adjusting the baseband input stage 150₂ to scale the signal amplitude in the auxiliary path 140₂. In another embodiment, the output gain of the fundamental component and harmonic distortion component(s) in RF_{OUT2} can be scaled (e.g., attenuated) by controlling the gain adjust stage 170₂ in the auxiliary path 140₂.

In some embodiments, as schematically illustrated in FIG. 1, the RF signal generator 102 comprises an analog quadrature system that is configured to generate quadrature (I/Q) baseband signals (e.g., baseband I/Q signals) and utilize quadrature local oscillator (LO) signals to perform quadrature modulation (or I/Q signal modulation) to thereby generate RF output signals for a given application. As is known in the art, a quadrature signal comprises an in-phase (I) signal component, and a quadrature-phase (Q) signal component. A pair of signals that are in quadrature have the same frequency, but differ in phase by 90 degrees. For example, by convention, the I signal component is a cosine waveform, and the Q signal component is a sine waveform. For illustrative purposes, exemplary embodiments of the disclosure will be described in the context of quadrature RF signal generator systems, although the exemplary signal processing circuitry and methods as discussed herein can be implemented with other types of RF signal generator systems and modulation techniques.

In the exemplary embodiment of FIG. 1, the baseband I/Q signal generator 110 is configured to generate digital quadrature signals I and Q which represent input baseband data for a given application. For example, for quantum computing applications, the baseband I/Q signal generator 110 is configured to implement pulse-shaping techniques to generate RF control pulses with desired envelope shapes (e.g., Gaussian pulses, cosine pulses (e.g., sum of half cosines), hyperbolic secant pulses, etc.), which are applied to superconducting qubits or active qubit coupler circuits to perform single qubit gate operations, entanglement gate operations, etc. In some embodiments, the baseband I/Q signal generator 110 implements digital signal processing techniques based on a combination of hardware and software to generate the digital quadrature baseband signals I and Q.

The DAC stage 120 comprises inputs that are coupled to outputs of the baseband I/Q signal generator 110. The DAC stage 120 is configured to convert the digital quadrature signals I and Q to analog baseband signals I′(t) and Q′(t) having a target baseband frequency. In particular, the DAC stage 120 comprises multi-bit DAC circuits including a first DAC circuit 121 and a second DAC circuit 122. The first DAC circuit 121 is configured to convert the digital baseband component I to an analog baseband component I′(t) having a baseband frequency, and the second DAC circuit 122 is configured to convert the digital baseband component Q to an analog baseband component Q′(t) having the same baseband frequency, but phase-shifted by 90 degrees relative to I′(t). The DAC stage 120 generates and outputs the analog baseband signals I′(t) and Q′(t) at a given sampling rate (fs) or sampling frequency, e.g., baseband frequencies in a range of about 100 kHz to about 1 GHz depending on the given application. In some embodiments, the first and second DAC circuits 121 and 122 implement a configurable hardware framework in which various operating parameters of the DAC stage 120 can be adjusted by digital control signals that are input to the DAC stage 120. For example, in some embodiments, the digital control can be utilized to adjust DAC operating parameters including, but not limited to, the sampling rate, analog full-scale output, etc.

Based on the Nyquist Sampling Theorem, the highest fundamental output frequency f_{O} signal a DAC with sampling frequency fₛ can generate is equal to half the sampling rate or fₛ/2 (referred to as the first Nyquist zone). In the frequency domain, when generating a sinusoidal waveform of frequency f_{O}, the fundamental baseband frequency f_{O} will appear as a spectral component at f_{O}, and there will be additional higher frequency components that are generated at the output of the DAC stage 120, which are referred to as “images” and which are a function of fₛ and f_{O}. For example, the higher frequency components are determined as |(n×fₛ)±f_{O}|, where n=1, 2, 3, . . . . The images have the same information content as the fundamental spectral components, but at higher frequencies and at smaller amplitudes. The unwanted images are suppressed/rejected using, e.g., the baseband filter stage 130.

The baseband filter stage 130 comprises inputs that are coupled to outputs of the DAC stage 120. The baseband filter stage 130 is configured to filter the analog baseband signals I′(t) and Q′(t) output from the DAC stage 120 to thereby generate filtered analog baseband signals I(t) and Q(t). The baseband filter stage 130 comprises a first filter circuit 131 and a second filter circuit 132. The first filter circuit 131 is configured to filter the in-phase analog signal I′(t) output from the first DAC circuit 121, and the second filter circuit 132 is configured to filter the quadrature-phase analog signal Q′(t) output from the second DAC circuit 122. In some embodiments, the first and second filter circuits 131 and 132 comprise low-pass filters that are configured to pass the fundamental spectral components of the respective analog signals I′(t) and Q′(t), while suppressing the image components of the respective analog signals I′(t) and Q′(t). In other embodiments, the first and second filter circuits 131 and 132 can be configured as bandpass filters to pass a desired band of higher frequency image components of the respective analog signals I′(t) and Q′(t), while suppressing the fundamental spectral components and other image components of the respective analog signals I′(t) and Q′(t). In other embodiments, the first and second filter circuits 131 and 132 can be configured as high-pass filters, as may be desired for a given application.

In some embodiments, the baseband filter stage 130 comprises configurable filter circuits in which, e.g., the cutoff frequencies of the first and second filter circuits 131 and 132 can be adjusted, or where the first and second filter circuits 131 and 132 can be configured to have different filter types (e.g., low-pass, band-pass, etc.) as desired for a given application. For example, in some embodiments, a bandpass filter can be configured using two low pass filters using known signal filtering techniques and architectures. In some embodiments, the filter configurations are digitally controlled by the digital control signals that are input to the baseband filter stage 130.

For example, a higher DAC sampling frequency can be utilized as needed to transmit baseband data and/or relax the filter response of the downstream filters of the baseband filter stage 130. Indeed, an increase in the DAC sampling frequency results in the possibility of accommodating higher baseband transmission frequency (i.e., the analog signals I′(t) and Q′(t) have a higher baseband frequency). In addition, an increase in the DAC sampling frequency results in an increase in the separation between the center frequency f_{O} of the baseband component and the center frequencies n×fₛ±f_{O} of the higher frequency images, which relaxes the required sharpness of the filter cutoffs at corner frequencies of the filters. However, the higher DAC sampling rate results in increased power consumption. So, a tradeoff in power consumption with DAC sampling frequency, and the sharpness of the filter cutoffs at the corner frequencies of the filters are factors that should be considered.

As schematically illustrated in FIG. 1, the output of the baseband filter stage 130 is coupled to inputs of the main path 140₁ and the auxiliary path 140₂. In particular, an output (filtered analog signal I(t)) of the first filter circuit 131 is coupled to inputs of both baseband input stages 150₁ and 150₂, and an output (filtered analog signal Q(t)) is coupled to inputs of both baseband input stages 150₁ and 150₂. As explained in further detail below, in some embodiments, the baseband input stages 150₁ and 150₂ are each configured to generate I and Q current signals that represent the filtered analog signals I(t) and Q(t), which are applied to baseband inputs of the respective mixer stages 160₁ and 160₂.

In some embodiments, the first and second filter circuits 131 and 132 are configured as current-mode baseband filters, where current-mode connections between the outputs of the current-mode baseband filters and inputs of the baseband input stages 150₁ and 150₂ arc implemented using current mirrors. In other embodiments, the first and second filter circuits 131 and 132 are configured as voltage-mode baseband filters, wherein the first and second filter circuits 131 and 132 are configured to output the filtered analog signals I(t) and Q(t) as analog voltage signals. In some embodiments, the baseband input stages 150₁ and 150₂ are configured as voltage-mode input stages, e.g., transconductance stages, that are configured to convert the analog voltage signals I(t) and Q(t) into currents that are applied to the baseband inputs the respective mixer stages 160₁ and 160₂. In other embodiments, the baseband input stages 150₁ and 150₂ are configured as current-mode input stages. It is to be noted that alternative exemplary embodiments of the baseband input stages 150₁ and 150₂ will be described in further detail below.

In some embodiments, the each mixer stage 160₁ and 160₂ is configured to perform analog I/Q signal modulation, e.g., single-sideband (SSB) modulation, by mixing the baseband current signals (which represent the filtered analog signals I(t) and Q(t)) that are output from the baseband filter stage 130, with quadrature LO signals (e.g., an in-phase LO signal (LO_I) and a quadrature-phase LO signal (LO_Q)) to generate and output an analog RF signal (e.g., a single-sideband modulated RF output signal). The local oscillator signals LO_I and LO_Q each have the same LO frequency, but the LO_Q signal is phase-shifted by 90 degrees relative to the LO_I signal. For amplitude modulation, the current signals I(t) and Q(t) that are output from the baseband input stages 150₁ and 150₂ amplitude modulate the LO_I and LO_Q signals that are input to the mixer stages 160₁ and 160₂.

The gain adjust stages 170₁ and 170₂ are configured to receive modulated RF signals, which is output from the respective mixer stages 160₁ and 160₂, and either amplify or attenuate the modulated RF signals to a desired power level, and drive the output of the RF signal generator 102 (e.g., drive an antenna, sensor device, qubit, etc., which is coupled to the output of the RF signal generator 102). In some embodiments, each gain adjust stage 170₁ and 170₂ comprises a programmable gain, wherein gain can be expressed as a difference between the input power level and the output power level or, more specifically, as a ratio of output to input power. In some embodiments, the gain adjust stages 170₁ and 170₂ are utilized to increase the power level of the RF output signal to a level which is sufficient to transmit (wirelessly or wired) the modulated RF signal at a given power level and over a required transmission distance. In other embodiments, the gain adjust stages 170₁ and 170₂ comprise programmable gain attenuation stages, which are configured to amplify a modulated RF signal with a gain factor of 1, or less than 1. In this manner, the gain adjust stages 170₁ and 170₂ can be controlled to attenuate the power level of modulated RF signals that are output from the respective mixer stages 160₁ and 160₂, as desired, for a given application.

The signal combiner and matching network 180 is configured to perform various functions. For example, the signal combiner and matching network 180 is configured to combine the RF signals RF_{OUT1} and RF_{OUT2} (e.g., current signals), which are output from the respective gain adjust stages 170₁ and 170₂, in a manner which cancels the harmonic distortion components of the RF signals RF_{OUT1} and RF_{OUT2}. In addition, the signal combiner and matching network 180 comprises an impedance matching network that is configured to match a source impedance or load impedance of the outputs of the mixer stages 160₁ and 160₂ to a characteristic impedance of an output load (e.g., antenna input, diplexer, etc.) of the RF signal generator 102. In some embodiments, the signal combiner and matching network 180 comprises a balun to convert a differential/balanced RF output signal to a single-ended/unbalanced output, wherein RF_OUT comprises a single-ended signal.

In some embodiments, the parameters of the impedance matching network of the signal combiner and matching network 180 (e.g., impedance at resonance and bandwidth) remain substantially invariant, wherein the impedance matching network is designed with a center frequency which corresponds to a desired operating frequency of the load. In other embodiments, the impedance matching network of the signal combiner and matching network 180 is configured with a plurality of injection points to provide different impedance matching and filtering characteristics. The different injection points can be selected by digital control signals applied to the impedance matching network. The impedance matching network can have high pass and low pass characteristics, wherein the different injection points can be selected to provide different impedance matching and response characteristics. In some embodiments, the impedance matching network is designed with a high-Q factor, wherein the center frequency of the impedance matching network can be adjusted to provide a desired impedance transformation for different transmission frequencies which are generated by, e.g., changing the sampling frequency of the DAC stage 120 and/or changing the LO frequency of the mixer stages 160₁ and 160₂, depending on the given application.

As schematically shown in FIG. 1, the various signal processing stages 110, 120, 130, 150₁, 150₂, 160₁, 160₂, 170₁, 170₂, and 180 of the RF signal generator 102 comprise control signal ports that receive digital control signals from either the calibration control system 190 or some processor or microcontroller which is configured to control operation of the RF signal generator 102. The calibration control system 190 is configured to generate digital control signals to configure the RF signal generator 102, or signal processing stages thereof, to operate in different modes. Further, in some embodiments, some or all of the stages 110, 120, 130, 150₁, 150₂, 160₁, 160₂, 170₁, 170₂, and 180 have a configurable hardware framework in which various operating parameters and/or components of the stages can be adjusted by the digital control signals for different operating modes of the RF signal generator 102.

It is to be understood that the RF signal generator system 100 can be implemented for various RF applications, wherein in the context of the exemplary embodiments discussed herein, an RF signal comprises a signal which has a frequency ranging from, e.g., about 20 kHz to about 300 GHz. For example, in some embodiments, the RF signal generator system 100 comprises an RF transmitter for a wireless application, wherein an output of the RF signal generator 102 is coupled to an antenna system which is configured to transmit an RF output signal that is generated by the RF signal generator 102. In other embodiments, the RF signal generator system 100 comprises a waveform generator (e.g., an AWG, or a function generator) in which the output of the RF signal generator 102 is coupled to an input of a sensor device, wherein the RF output signal RF_OUT that is generated by the RF signal generator 102 is configured to excite the sensor device. In other embodiments, for quantum computing applications, the RF signal generator system 100 comprises an AWG system which is configured to generate an RF control pulse for controlling the operation of, e.g., a superconducting qubit, an active superconducting coupler circuit which couples two superconducting qubits, or other superconducting quantum devices, etc.

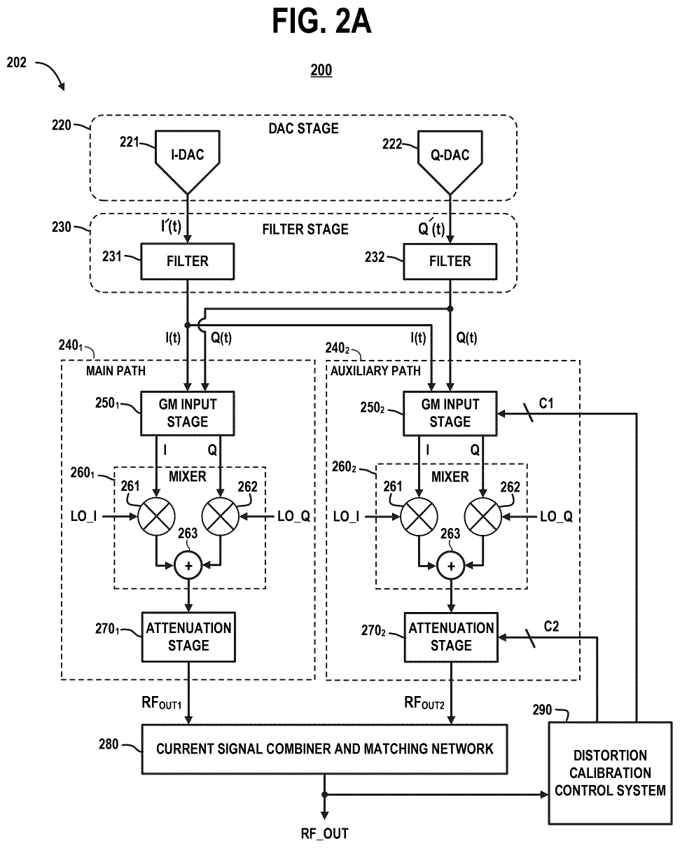

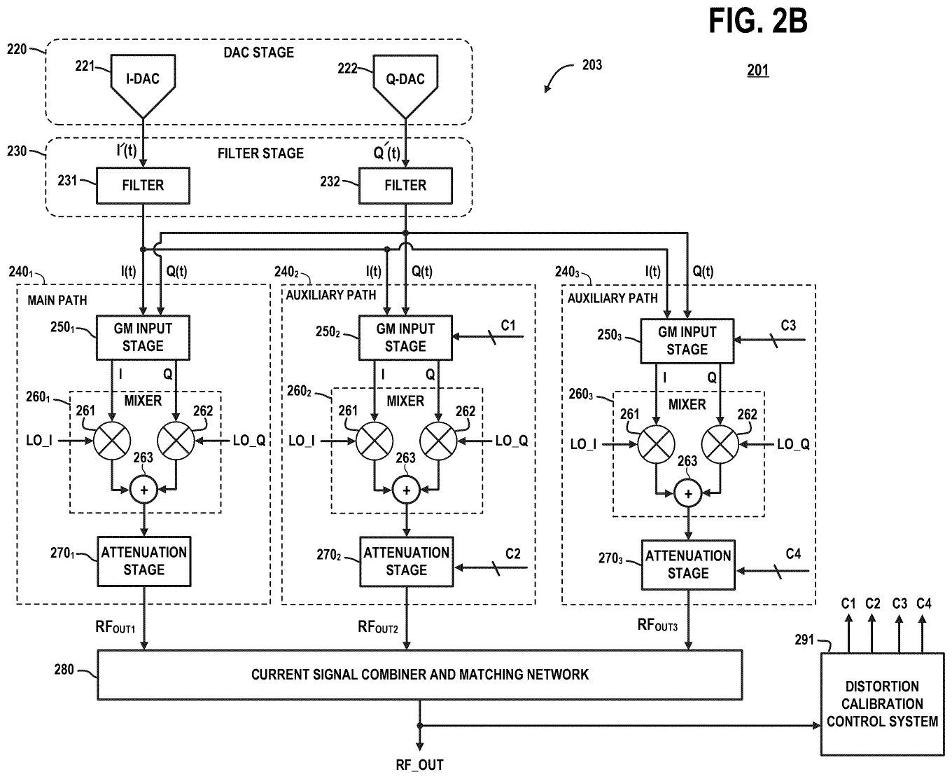

It is to be noted that the RF signal generator 102 shown in FIG. 1 can be implemented using various types of circuit architectures and signal processing techniques. For example, FIG. 2A schematically illustrates a radio frequency signal generator system which is configured to generate radio frequency signals with suppressed harmonic distortion, according to another exemplary embodiment of the disclosure. In particular, FIG. 2A schematically illustrates an RF signal generator system 200 which comprises an RF signal generator 202 that is based on the exemplary architecture of the RF signal generator 102 of FIG. 1, wherein the RF signal generator 202 comprises a DAC stage 220, a baseband filter stage 230, a first RF signal path 240₁ (alternatively, main path 240₁), a second RF signal path 240₂ (alternatively, auxiliary path 240₂), and a current signal combiner and matching network 280. The DAC stage 220 comprises a first DAC 221 (or I-DAC), and a second DAC 222 (or Q-DAC). The baseband filter stage 230 comprises a first filter 231 and a second filter 232. In some embodiments, the DAC stage 220 and the baseband filter stage 230 are implemented using the same or similar circuit architectures and signal processing techniques as the DAC stage 120 and baseband filter stage 130, as discussed above in conjunction with FIG. 1, the details of which need not be repeated.

The main path 240₁ and the auxiliary path 240₂ comprise RF signal generation paths that are coupled in parallel between an output of the baseband filter stage 230 and an input of the current signal combiner and matching network 280. The main path 240₁ comprises a transconductance (gm) baseband input stage 250₁, a mixer stage 260₁, and an attenuation stage 270₁. Similarly, the auxiliary path 240₂ comprises a transconductance (gm) baseband input stage 250₂, a mixer stage 260₂, and an attenuation stage 270₂.

The transconductance baseband input stages 250₁ and 250₂ have nominally identical circuit architectures are configured to generate and output baseband current signals (denoted I and Q, in FIG. 2A) to the respective mixer stages 260₁ and 260₂ in response to filtered baseband input signals I(t) and Q(t) which are output from the respective first and second filters 231 and 232. As explained in further detail below, the transconductance baseband input stages 250₁ and 250₂ can be implemented using a voltage-mode architecture or a current-mode architecture.

The mixer stages 260₁ and 260₂ have nominally identical circuit architectures, wherein the mixer stages 260₁ and 260₂ each comprise a first mixer 261 (or I-mixer), a second mixer 262 (or Q-mixer), and a signal combiner 263. In the mixer stage 260₁ of the main path 240₁, the first mixer 261 is configured to mix the baseband signal (I) output from the transconductance baseband input stage 250₁ with an LO_I signal and generate a first RF signal output, the second mixer 262 is configured to mix the baseband signal (Q) output from the transconductance baseband input stage 250₁ with an LO_Q signal and generate a second RF signal output, and the signal combiner 263 is configured to combine (e.g., add) the first and second RF signal outputs from the first and second mixers 261 and 262 to generate a single-sideband RF signal which is output from the mixer stage 260₁. Similarly, in the mixer stage 260₂ of the auxiliary path 240₂, the first mixer 261 is configured to mix the baseband signal (I) output from the transconductance baseband input stage 250₂ with the LO_I signal and generate a first RF signal output, the second mixer 262 is configured to mix the baseband signal (Q) output from the transconductance baseband input stage 250₂ with the LO_Q signal and generate a second RF signal output, and the signal combiner 263 is configured to combine (e.g., add) the first and second RF signal outputs from the first and second mixers 261 and 262 to generate a single-sideband RF signal which is output from the mixer stage 260₂.

In some embodiments, each mixer stage 260₁ and 260₂ is configured to perform an upconversion mixing process to generate an RF analog signal which has a center frequency that is greater than the baseband frequency of the baseband signals output from the DAC stage 220. In some embodiments, the LO frequency is in a range of 100 MHz to about 10 GHz, depending on the application. More specifically, as is understood by those of ordinary skill in the art, as a result of the mixing operations by the first and second mixers 261 and 262, the RF signal outputs from the first and second mixers 261 and 262 each comprise a double-sideband RF signal. A double-sideband RF signal comprises an upper sideband (USB) and a lower sideband (LSB) which are disposed at equal distances above and below the LO frequency. The upper sideband comprises a spectral band of frequencies that is higher than the LO frequency, and the lower sideband comprises a spectral band of frequencies that is lower than the LO frequency. The upper and lower sidebands each carry the same information content of the I/Q signals. For example, assume that the baseband signals I and Q (i.e., the modulating signals) have a center frequency F_{BB} (intermediate frequency) and that the LO signal has a frequency F_{LO}. The first and second RF signals that are output from the first and second mixers 261 and 262 will each have (i) an upper sideband of spectral components, which is frequency-band centered at a frequency of (F_{LO}+F_{BB}) and (ii) a lower sideband of spectral components, which is frequency-band centered at a frequency of (F_{LO}−F_{BB}).

In some embodiments, the signal combiner 263 in each mixer stage 260₁ and 260₂ is configured to add the RF signals which are output from the first and second mixers 261 and 262, in which case the signal combiner 263 will output the “real” lower sideband signal as a single-sideband modulated RF signal (with a suppressed carrier frequency) having a center frequency which is upconverted from baseband the frequency F_{BB} to a center frequency (F_{LO}−F_{BB}) of the lower sideband. In other embodiments, the signal combiner 263 is configured to subtract the RF signals which are output from the first and second mixers 261 and 262, in which case the signal combiner 263 will output the “real” upper sideband signal as a single-sideband modulated RF signal (with a suppressed carrier) having a center frequency which is upconverted from the baseband frequency F_{BB} to a center frequency (F_{LO}+F_{BB}) of the upper sideband.

In other embodiments, each mixer stage 260₁ and 260₂ is configured as a double-sideband modulator (with a suppressed carrier frequency). More specifically, each mixer stage 260₁ and 260₂ can be configured to provide double-sideband modulation by maintaining the LO_Q input to the second mixer 262 at a constant zero voltage level (i.e., LO_Q=0). In this instance, the second mixer 262 will have a zero output (i.e., no RF signal is output from the second mixer 262), and the output of the signal combiner 263 will be the double-sideband RF signal output from the first mixer 261.

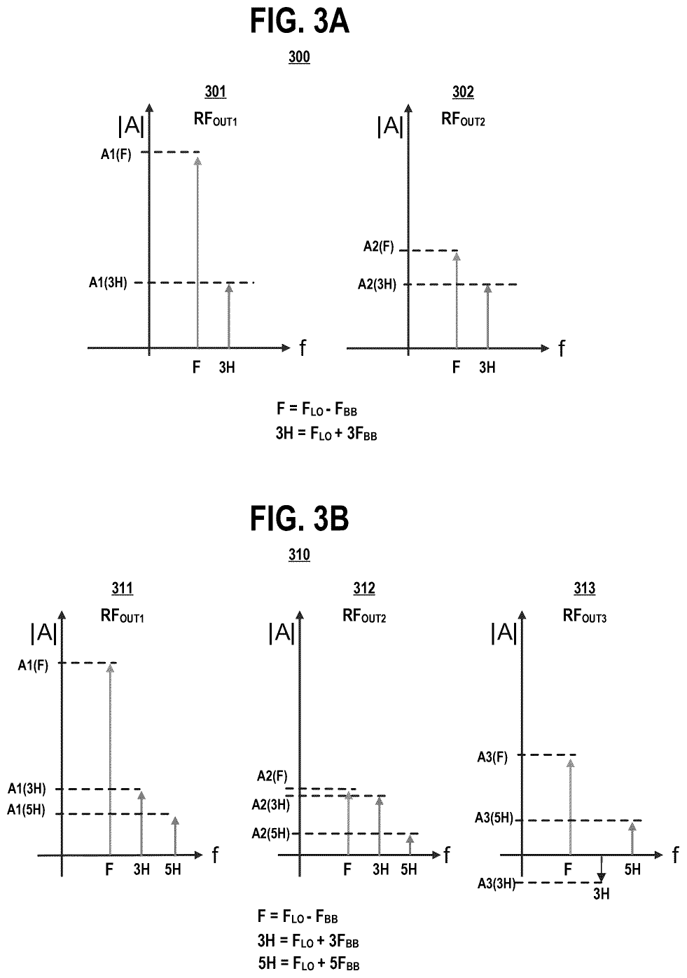

Similar to the exemplary RF signal generator 102 of FIG. 1, the exemplary architecture of the RF signal generator 202 shown in FIG. 2A implements multiple RF signal paths, which operate in parallel, to generate a resulting RF output signal RF_OUT with significantly suppressed (or canceled) harmonic distortion components, and at low power consumption. In particular, the main path 240₁ and the auxiliary path 240₂ are configured to operate in parallel to generate respective first and second output signals RF_{OUT1} and RF_{OUT2}, which are combined to cancel or otherwise significantly suppress, e.g., a 3H distortion component in the resulting RF output signal, as will be explained in further detail below in conjunction with FIG. 3A.

In addition, as schematically illustrated in FIG. 2A, the RF signal generator system 200 comprises a distortion calibration control system 290 which is configured to, e.g., perform spectral analysis of an RF output signal RF_OUT, which is generated by the RF signal generator 202, to assess the quality of the RF output signal, and generate a plurality of distortion calibration control signals, e.g., C1 and C2, to calibrate operating parameters of the transconductance baseband input stage 250₂ and attenuation stage 270₂ in the auxiliary path 240₂ to, e.g., optimize the suppression or cancellation of distortion components (e.g., suppress or cancel 3H spur) in the RF output signal RF_OUT, or otherwise achieve a desired SFDR. The distortion calibration control system 290 can operate at power-up (startup) of the RF signal generator 202 to perform distortion calibration operations, as well as operate periodically or on demand during real-time operation of the RF signal generator 202 to make further calibration adjustments, as needed, to optimize 3H distortion suppression by, e.g., keeping the power level of the 3H distortion component in the resulting RF output signal RF_OUT at or below a target level.

While FIGS. 1 and 2A illustrate exemplary embodiments of RF signal generators that implement two parallel paths (main path and auxiliary path) to suppress 3H distortion components, one or more additional auxiliary paths can be implemented to enable suppression of higher odd-order distortion components (e.g., 5H distortion component, 7H distortion component, etc.), as desired. For example, FIG. 2B schematically illustrates a radio frequency signal generator system which is configured to generate radio frequency signals with suppressed harmonic distortion, according to another exemplary embodiment of the disclosure. In particular, FIG. 2B schematically illustrates an RF signal generator system 201 which comprises an RF signal generator 203 that is based on the exemplary architecture of the RF signal generator 202 of FIG. 2A, except that the RF signal generator 203 has three parallel paths, including the first RF signal path 240₁ (main path 240₁) which generates the second RF signal path 240₂ (or first auxiliary path 240₂), and a third RF signal path 240₃ (or second auxiliary path 240₃). The second auxiliary path 240₃ provides an additional auxiliary path with suitable non-linear characteristics to enable suppression/cancellation of a 5H distortion component in the resulting RF output signal RF_OUT.

As schematically illustrated in FIG. 2B, the second auxiliary path 240₃ comprises a transconductance (gm) baseband input stage 250₃, a mixer stage 260₃, and an attenuation stage 270₃. The main and auxiliary paths 240₁, 240₂, and 240₃ have nominally identical architectures, but each operate in parallel at different power levels and distortion levels, as discussed above, to suppress/cancel 3H and 5H distortion terms in the resulting RF output signal RF_OUT. Similar to the first auxiliary path 240₂, the second auxiliary path 240₃ operates at an ultra-low power level and a relatively high distortion level. The main path 240₁, the first auxiliary path 240₂, and the second auxiliary path 240₃ are configured to operate in parallel to generate respective first, second, and third output signals RF_{OUT1}. RF_{OUT2}, and RF_{OUT3}, which are combined (via the current signal combiner and matching network 280) to cancel or otherwise significantly suppress 3H and 5H distortion components in the resulting RF output signal, as will be explained in further detail below in conjunction with FIG. 3B.

In addition, as schematically illustrated in FIG. 2B, the RF signal generator system 201 comprises a distortion calibration control system 291 which is configured to, e.g., perform spectral analysis of an RF output signal RF_OUT, which is generated by the RF signal generator 203, to assess the quality of the RF output signal, and generate a plurality of distortion calibration control signals, e.g., C1, C2, C3, and C4 to calibrate operating parameters of the transconductance baseband input stages 250₂ and 250₃, and the attenuation stages 270₂ and 270₃ in the first and second auxiliary paths 240₂ and 240₃ to, e.g., optimize the suppression or cancellation of the 3H and 5H distortion components in the resulting RF output signal RF_OUT, or otherwise achieve a desired SFDR. Again, the distortion calibration control system 291 can operate at power-up (startup) of the RF signal generator 203 to perform distortion calibration operations, as well as operate periodically or on demand during real-time operation of the RF signal generator 203 to make further calibration adjustments, as needed, to optimize 3H and 5H distortion suppression by, e.g., keeping the power levels of the 3H and 5H distortion components in the resulting RF output signal RF_OUT at or below a target level.

FIG. 3A schematically illustrates a method of utilizing multiple parallel RF paths of an RF signal generator to achieve harmonic distortion suppression, according to an exemplary embodiment of the disclosure. In particular, FIG. 3A schematically illustrates a method 300 of utilizing two parallel RF paths of an RF signal generator to suppress a 3H distortion component in a resulting RF output signal. For purposes of illustration, FIG. 3A will be discussed in the context of the exemplary RF signal generator system 200 of FIG. 2A in which the RF signal generator 202 comprises the main path 240₁ which generates a first RF output signal RF_{OUT1}, and the auxiliary path 240₂ which generates a second RF output signal RF_{OUT2}. In this regard, FIG. 3A depicts a first frequency-domain graph 301 (or spectrum plot) and a second frequency-domain graph 302, wherein the X-axis plots frequency, and the Y-axis plots amplitude. The first frequency-domain graph 301 shows frequency components of a first RF signal RF_{OUT1} which is generated and output from the main path 240₁, and the second frequency-domain graph 302 shows frequency components of a second RF signal RF_{OUT2} which is generated and output from the auxiliary path 240₂.

In particular, the first frequency-domain graph 301 shows frequency components of the first RF signal RF_{OUT1}, wherein such frequency components include a fundamental frequency component (F), and a third-order harmonic frequency component (3H). Similarly, the second frequency-domain graph 302 shows frequency components of the second RF signal RF_{OUT2}, wherein such frequency components include a fundamental frequency component (F), and a third-order harmonic frequency component (3H). In both RF_{OUT1} and RF_{OUT1}, the fundamental frequency component (F) has a frequency of F=F_{LO}−F_{BB}, which represents the lower side band (LSB) of the SSB modulated signals generated by the mixer stages 260₁ and 260₂ in the main and auxiliary paths 240₁ and 240₂ (where F_{LO} denotes the LO signal frequency, and F_{BB} denotes the baseband signal frequency). Furthermore, in both RF_{OUT1} and RF_{OUT1}, the third-order harmonic frequency component (3H) has a frequency of 3H=F_{LO}+3F_{BB}. For illustrative purposes, the frequency components are pure tones that are graphically illustrated as delta pulses in the frequency domain, where the height of a given delta pulse represents an amplitude of the given frequency component.

As shown in the first frequency-domain graph 301, the fundamental frequency component F of RF_{OUT1} has an amplitude of A1(F), and the 3H frequency component of RF_{OUT1} has an amplitude of A1(3H). As further shown in the second frequency-domain graph 302, the fundamental frequency component F of RF_{OUT2} has an amplitude of A2(F), and the 3H frequency component of RF_{OUT2} has an amplitude of A2(3H). The first and second frequency-domain graphs 301 and 302 illustrate that the amplitude A1(F) of the fundamental frequency component F of RF_{OUT1} is greater than the amplitude A2(F) of the fundamental frequency component F of RF_{OUT1} (i.e., A1(F)>A2(F)). Moreover, the first and second frequency-domain graphs 301 and 302 illustrate that the amplitudes A1(3H) and A2(3H) of the 3H frequency components of the respective signals RF_{OUT1} and RF_{OUT2} are the same (e.g., A1(3H)=A2(3H)).

In this instance, the signals RF_{OUT1} and RF_{OUT2} can be combined (via the current signal combiner and matching network 280) to generate a resulting RF output signal RF_OUT by subtracting the signals, e.g., RF_OUT=RF_{OUT1}−RF_{OUT2}, which essentially results in cancellation of the 3H frequency component. As a result, the resulting RF output signal has virtually no 3H distortion component (or a substantially suppressed 3H distortion component. It is to be noted that while generating RF_OUT=RF_{OUT1}−RF_{OUT2} does result in some power loss (reduction in amplitude) of the resulting fundamental component F in RF_OUT, the main and auxiliary paths 240₁ and 240₂ can be calibrated so that the amplitude A1(F) of the fundamental frequency component F of RF_{OUT1} is greater than the amplitude A2(F) of the fundamental frequency component F of RF_{OUT2} (i.e., A1(F)>A2(F)) by a factor of, e.g., 10:1 or 20:1, to realize a small loss of power of the fundamental component F by not more than 5%-10%, which is acceptable.

As noted above, a calibration process can be implemented to ensure that the amplitudes of the 3H frequency components of the respective signals RF_{OUT1} and RF_{OUT2} are made equal (or substantially equal) to ensure a cancellation or a substantial suppression of the 3H distortion component in the resulting RF output signal RF_OUT. Such calibration can be achieved by (i) scaling the signal amplitude in the auxiliary path 240₂ by adjusting the gain of the transconductance baseband input stage 250₂ and/or (ii) adjusting the attenuation level in the auxiliary path 240₂ by operation of the attenuation stage 270₂. The attenuation stage 270₂ provides broadband operation, such that adjusting the attenuation level provides the same attenuation level adjustment for the fundamental frequency component and the 3H distortion component.

It is to be noted that the signs of the distortion components (e.g., 3H distortion components) in RF_{OUT1} and RF_{OUT2} are dependent on the type of nonlinearity (compressive or expansive) of, e.g., the transconductance baseband input stages 250₁ and 250₂. Compressive and expansive nonlinearities are types of nonlinear behaviors that affect system performance. With compressive nonlinearity, a signal output increases at a decreasing rate as the input increases, which helps to prevent distortion by limiting the amplitude of the signal. On the other hand, with expansive nonlinearity, a signal output increases at an increasing rate as the input increases (e.g., for a transconductance stage, current output increases more rapidly than the input voltage.

In this regard, depending on the relative signs of the distortion components in RF_{OUT1} and RF_{OUT2,} harmonic distortion cancellation can be achieved by addition (e.g., RF_OUT=RF_{OUT1}+RF_{OUT2}) or subtraction, e.g., RF_OUT=RF_{OUT1}−RF_{OUT2}. In general, for the exemplary configuration comprising two RF paths, the main path 240₁ and the auxiliary path 240₂, harmonic distortion cancellation can be achieved in the resulting RF output signal RF_OUT by combining RF_{OUT1} and RF_{OUT2} as: RF_OUT=+RF_{OUT1}−(±RF_{OUT2}).

Next, FIG. 3B schematically illustrates a method of utilizing multiple parallel RF paths of an RF signal generator to achieve harmonic distortion suppression, according to another exemplary embodiment of the disclosure. In particular, FIG. 3B schematically illustrates a method 310 of utilizing three parallel RF paths of an RF signal generator to suppress 3H and 5H distortion components in a resulting RF output signal. For purposes of illustration, FIG. 3B will be discussed in the context of the exemplary RF signal generator system 201 of FIG. 2B in which the RF signal generator 203 comprises the main path 240₁ which generates a first RF output signal RF_{OUT1}, the first auxiliary path 240₂ which generates the second RF output signal RF_{OUT2}, and the second auxiliary path 240₃ which generates the third RF output signal RF_{OUT3}.

In this regard, FIG. 3B depicts a first frequency-domain graph 311, a second frequency-domain graph 312, and a third frequency-domain graph 313. The first frequency-domain graph 311 shows frequency components of the first RF signal RF_{OUT1}, the second frequency-domain graph 312 shows frequency components of the second RF signal RF_{OUT2}, and the third frequency-domain graph 313 shows frequency components of the third RF signal RF_{OUT3}, In particular, the first, second, and third frequency-domain graphs 311, 312, and 313 show fundamental frequency components (F), third-order harmonic (3H) frequency components, and fifth-order (5H) harmonic frequency components of RF_{OUT1}, RF_{OUT2}, and RF_{OUT3}, where F=F_{LO}−F_{BB} (LSB of the SSB modulated signals generated by the mixer stages 260₁, 260₂, and 260₃). where 3H=F_{LO}+3F_{BB}, and where 5H=F_{LO}+5F_{BB}. For illustrative purposes, the frequency components are pure tones that are graphically illustrated as single vertical spikes, where a height of a given spike represents an amplitude of the given frequency component.

As shown in the first frequency-domain graph 311, the signal RF_{OUT1} has a fundamental frequency component F with an amplitude of A1(F), a 3H frequency component with an amplitude of A1(3H), and a 5H frequency component with an amplitude of A1(5H). As further shown in the second frequency-domain graph 312, the signal RF_{OUT2} has a fundamental frequency component F with an amplitude of A2(F), a 3H frequency component with an amplitude of A2(3H), and a 5H frequency component with an amplitude of A2(5H). As further shown in the third frequency-domain graph 313, the signal RF_{OUT3} has a fundamental frequency component F with an amplitude of A3(F), a 3H frequency component with an amplitude of A3(3H), and a 5H frequency component with a negative amplitude of A3(5H).

In the exemplary embodiment shown in FIG. 3B, depending on the amplitudes of the frequency components of the signals RF_{OUT1}, RF_{OUT2}, and RF_{OUT3}, a resulting RF output signal RF_OUT can be generated by the following signal combining: RF_OUT=+RF_{OUT1}−(+RF_{OUT2})−(±RF_{OUT3}), to cancel or otherwise substantially suppresses the 3H and 5H frequency components in the resulting RF output signal RF_OUT, while minimizing power loss (reduction in amplitude) of the resulting fundamental component Fin RF_OUT. As noted above, a calibration process can be implemented to ensure that the amplitudes of the 3H and 5H frequency components of the respective signals RF_{OUT1}, RF_{OUT2}, and RF_{OUT3} result in the cancellation or substantial suppression of the 3H and 5H distortion components in the resulting RF output signal RF_OUT.

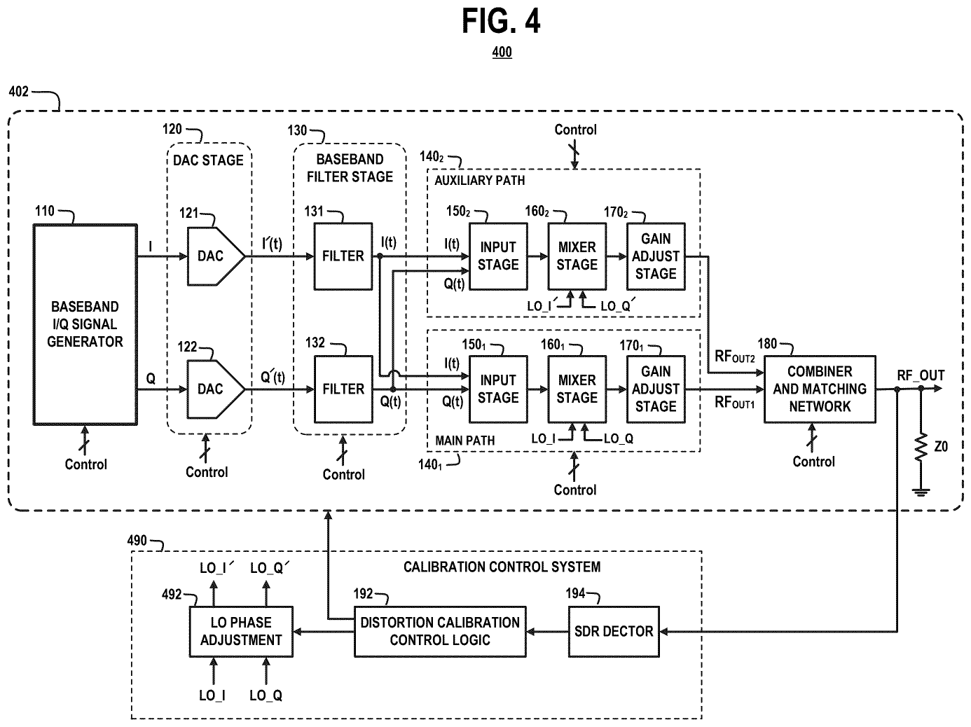

It is to be noted that in certain design implementations, the phases of the harmonic frequency components in the main path and auxiliary paths may not match as a result of, e.g., different current densities, process mismatches, layout mismatches etc. In such instances, the proper cancellation of harmonic distortion components can be achieved by applying a suitable phase shift to the LO signals that are applied to the auxiliary path(s). For example, FIG. 4 schematically illustrates a radio frequency signal generator system which is configured to generate radio frequency signals with suppressed harmonic distortion, according to another exemplary embodiment of the disclosure, wherein phase compensation is implemented to optimize harmonic distortion cancellation.

In particular, FIG. 4 schematically illustrates a radio frequency signal generator system 400 which comprises an RF signal generator 402 and calibration control system 490. The RF signal generator 402 is similar in architecture and operation as the RF signal generator 102 discussed above in conjunction with FIG. 1, except that in the RF signal generator 402 of FIG. 4, phased-delayed quadrature LO signals, denoted LO_I′ and LO_Q′, are applied to the LO input ports of the mixer stage 160₂ in the auxiliary path 140₂. Moreover, the calibration control system 490 is similar in architecture and operation as the calibration control system 190 of the RF signal generator system 100 discussed above in conjunction with FIG. 1, except that in the calibration control system 490 comprises an LO phase adjustment circuit 492 which is configured to apply an adjustable phase delay to the quadrature LO signals LO_I and LO_Q to generate the phased-delayed quadrature LO signals LO_I′ and LO_Q′. In some embodiments, the quadrature LO signals LO_I and LO_Q are concurrently applied to the LO phase adjustment circuit 492 and the LO input ports of the mixer stage 160₁ in the main path 140₁, while the phased-delayed quadrature LO signals LO_I′ and LO_Q′ are output from the LO phase adjustment circuit 492 and input to the LO input ports of the mixer stage 160₂ in the auxiliary path 140₂.

In some embodiments, the amount of phase-delay provided by the LO phase adjustment circuit 492 is adjustably controlled by the distortion calibration control logic 192. In some embodiments, the LO phase adjustment circuit 492 is implemented using phase interpolator. In other embodiments, the LO phase adjustment circuit 492 is implemented using analog delay lines with variable delay. The LO phase adjustment circuit 492 can be implemented using any suitable types of phase-shifting circuits or techniques. It is to be noted that to cancel/suppress higher order harmonic components (e.g., 5H and 7H), additional parallel auxiliary paths would be added in the RF signal generator 402, where multiple LO phase adjustment circuits would be utilized to generate phase-delayed LO signals for respective mixer stages in the auxiliary paths.

To illustrate the use of phase compensation for proper H3 distortion cancellation in the exemplary RF signal generator 402 of FIG. 4, the following table shows simulated metrics and parameters associated with applying different phase shifts to quadrature LO signals, LO_I and LO_Q:

TABLE 1

| | Main | Auxiliary | | | |
|---|---|---|---|---|---|
| | Path | Path | No Delay | 90° Delay | 45° Delay |
| Fundamental | −101.1° | −101.8° | −20.3 dBm | −19.0 dBm | −19.6 dBm |
| H3 | −171.2° | −125.8° | −46.5 dBc | −55.3 dBc | −86.7 dBc |

In this exemplary use case, the main path 140₁ operates at a first current density and achieves a phase shift of −171.2° for the H3 component, and the auxiliary path 140₂ operates at a second current density and achieves a phase shift of −125.8° for the H3 component, which results in a phase difference of about −45.4° between the H3 components of the main and auxiliary paths. In addition, at the given current densities, there is a slight phase difference of about-0.7° between the fundamental components of the main and auxiliary paths.

As further shown in Table 1, without phase compensation (no delay), the fundamental component in the resulting RF output signal has a power level of −20.3 dBm, and the H3 distortion component has an SFDR of −46.5 dBc. However, with a phase compensation (90° delay), the fundamental component in the resulting RF output signal has a power level of −19.0 dBm, and the H3 distortion component has an SFDR of −55.3 dBc, which provides more suppression of the H3 distortion component. Furthermore, with a phase compensation (45° delay), the fundamental component in the resulting RF output signal has a power level of −19.6 dBm, and the H3 distortion component has an SFDR of −86.7 dBc, which provides even more suppression of the H3 distortion component. In this example, the phase difference between the H3 components of the main and auxiliary paths is 45.4°, so moving closer to the target value 45.4°, from a delay of 90° to a delay of 45° delay, results in an additional 9.4 dBc of H3 cancellation, while providing a slight reduction (e.g., 0.6 dBm) of the power level of the resulting fundamental component. It is to be noted that a 90° delay can be readily achieved by selecting the appropriate phase of the LO_I and LO_Q signals, which already have a 90° phase shift. On the other hand, achieving a custom phase delay other than a 90° delay would be achieved using the LO phase adjustment circuit 492.

The following analysis demonstrates exemplary operating modes of an RF signal generator which comprises a main path and one auxiliary path for suppressing H3 distortion components, where the main path and the auxiliary path are implemented using baseband stages with different types of nonlinearities, e.g., a compressive (C) nonlinearity, and an expansive (E) nonlinearity, a same type of nonlinearity. A baseband stage with an expansive (E) characteristic can be implemented using, e.g., a square-law MOS transconductance stage, or exponential bipolar transistor stage. A baseband stage with a compressive (C) characteristic can be implemented using, e.g., a source-coupled differential MOS transistor stage, a degenerated differential MOS transistor stage, a non-degenerated velocity saturated MOS transistor stage, etc. In accordance with exemplary embodiments of the disclosure distortion cancellation can be performed in two ways: (a) combining the distortion components from two stages with opposite types of nonlinearities (E, C) or (C, E), or (b) combining the distortion components from two stages with the same type of nonlinearity (C, C) or (E, E). In most scaled CMOS technologies, compressive type is more common, but the actual nature is highly dependent on current densities.

The exemplary analysis demonstrates that an X° phase shift in a fundamental component leads to 3X° phase shift in the H3 component. In addition, the exemplary analysis demonstrates that once a relative phase difference of the H3 components between the main and auxiliary paths becomes equal to an already existing phase in a quadrature LO system, the existing quadrature LO phase can be used without utilizing, e.g., a delay line for a custom phase shift. As noted above, while a 90° delay can be readily achieved by selecting the appropriate phase of the LO_I and LO_Q signals, a delay line or other phase shift circuitry can be used to achieve a custom phase shift to further optimize H3 cancellation.

Assume that the main path and the auxiliary path are both are modeled by a simple polynomial with dominant terms up to the 3rd order, where Y(t) represents a voltage (or a current), where and x(t) represents a voltage (or a current). For example, in an exemplary embodiment where the baseband input stage comprises a transconductance (gm) stage, Y(t) represents current, and x(t) represents voltage.

In this regard, Y(t)=α₁×(t)+α₃x³(t), where x(t)=A cos(ω_{BB}t), and x_{Q}(t)=A sin(ω_{BB}t), and assume a phase shift. Assume further that the main path is expansive, where (α₁ₑ*α₃ₑ)>0, to provide high gain at low power (where α₁ₑ and α₃ₑ denote expansive (e) coefficients). Moreover, assume that the auxiliary path is compressive, where (α_{1C}*α_{3C})<0, to provide high distortion at ultra-low power (where and α_{3C} denote compressive (c) coefficients). In a quadrature system with I and Q components, the I and Q currents in the main path are represented as:

$${Y}_{MAIN , I} ( t ) = {α}_{1 e} A cos ( {ω}_{b b} t + θ ) + {α}_{3 e} {A}^{3} {cos}^{3} ( {ω}_{b b} t + θ ) = [ {α}_{1 e} A + ( 3 / 4 ) {α}_{3 e} {A}^{3} ] cos ( {ω}_{b b} t + θ ) + {α}_{3 e} ( 3 / 4 ) {A}^{3} cos ( 3 {ω}_{b b} t + 3 θ ) , and$$

$${Y}_{MAIN , Q} ( t ) = {α}_{1 e} A sin ( {ω}_{b b} t ) + {α}_{3 e} {A}^{3} {sin}^{3} ( {ω}_{b b} t ) = [ {α}_{1 e} A + ( 3 / 4 ) {α}_{3 e} {A}^{3} ] sin ( {ω}_{b b} t + θ ) - {α}_{3 e} ( 3 / 4 ) {A}^{3} sin ( 3 {ω}_{b b} t + 3 θ ) .$$

Moreover, in the quadrature system, the I and Q currents in the auxiliary path can be represented as:

$${Y}_{AUX , I} ( t ) = {α}_{1 c} A cos ( {ω}_{b b} t ) + {α}_{3 c} {A}^{3} {cos}^{3} ( {ω}_{b b} t ) = [ {α}_{1 c} A + ( 3 / 4 ) {α}_{3 c} {A}^{3} ] cos ( {ω}_{b b} t + φ ) + {α}_{3 c} ( 3 / 4 ) {A}^{3} cos ( 3 {ω}_{bbt} + 3 φ ) ; and$$

$${Y}_{AUX , Q} ( t ) = {α}_{1 c} A sin ( {ω}_{b b} t ) + {α}_{3 c} {A}^{3} {sin}^{3} ( {ω}_{b b} t ) = [ {α}_{1 c} A + ( 3 / 4 ) {α}_{3 c} {A}^{3} ] sin ( {ω}_{b b} t + φ ) - {α}_{3 c} ( 3 / 4 ) {A}^{3} sin ( 3 {ω}_{b b} t + 3 φ ) .$$

Assume that the sign of α₁ₑ and α_{1c} are the same, so α₃ₑ and α_{3c} are of a different sign, it is also possible to use two compressive characteristics. For example, the following provides a mathematical derivation with regard to combining output signals from the main and auxiliary paths having a same type of nonlinearity characteristic, e.g., compressive characteristic. Moreover, the following exemplary analysis assumes that the main and auxiliary paths operate in current mode and combine lower sideband (LSB) signals from the main and auxiliary paths to cancel 3H distortion components. The desired LSB output (M) for the main path is represented as:

$${Y}_{RF , MAIN} ( t ) = {Y}_{MAIN , I} ( t ) cos ( {ω}_{LO} t ) + {Y}_{MAIN , Q} ( t ) sin ( {ω}_{LO} t ) , which is further represented as :$$

$${Y}_{R F , M A I N} ( t ) = [ {α}_{1 c M} A + ( 3 / 4 ) {α}_{3 cM} {A}^{3} ] cos \{ ( {ω}_{LO} - {ω}_{bb} ) t + θ \} + {α}_{3 cM} ( 3 / 4 ) {A}^{3} cos \{ ( {ω}_{LO} + 3 {ω}_{bb} ) t + 3 θ \} .$$

Next, the desired LSB output for the auxiliary path can be created in two ways. For example, in some embodiments, a first LSB output (A1) for the auxiliary path can be represented as:

$${Y}_{RF , AUX} ( t ) = {Y}_{AUX , I} ( t ) sin ( {ω}_{LO} t ) - {Y}_{AUX , Q} ( t ) cos ( {ω}_{LO} t ) , which is further represented as :$$

$${Y}_{RF , AUX} ( t ) = [ {α}_{1 cA} A + ( 3 / 4 ) {α}_{3 cA} {A}^{3} ] sin \{ ( {ω}_{LO} - {ω}_{bb} ) t + φ \} + {α}_{3 cA} ( 3 / 4 ) {A}^{3} sin \{ ( {ω}_{LO} + 3 {ω}_{bb} ) t + 3 φ \} .$$

In other embodiments, a second LSB output (A2) for the auxiliary path can be represented as:

$${Y}_{RF , AUX} ( t ) = {Y}_{AUX , I} ( t ) cos ( {ω}_{LO} t ) + {Y}_{AUX , Q} ( t ) sin ( {ω}_{LO} t ) , which is further represented as :$$

$${Y}_{RF , AUX} ( t ) = [ {α}_{1 cA} A + ( 3 / 4 ) {α}_{3 cA} {A}^{3} ] cos \{ ( {ω}_{LO} - {ω}_{bb} ) t + φ \} + {α}_{3 cA} ( 3 / 4 ) {A}^{3} cos \{ ( {ω}_{LO} + 3 {ω}_{bb} ) t + 3 φ \} .$$

The fundamental sideband component in the output signal from the auxiliary path is much smaller than the corresponding fundamental sideband component in the output signal from the main path (e.g., smaller by 12 dB-15 dB, or so). Considering H3 cancellation, and based on the corresponding phase shifts θ and φ, several cases are possible. In a generic sense, these phase shifts can be provided by a delay line in the LO path or a phase shifter in the RF path. Another mechanism is to is to obtain as much cancellation as possible with 90° phase granularity inherent to the LO path as a result of the existing phase difference between the LO_I and LO_Q signals.

Next, the following provides a mathematical derivation with regard to combining output signals from the main path and the auxiliary path having different types of nonlinearity characteristics, wherein, e.g., the main path is expansive and the auxiliary path is compressive. Moreover, the following exemplary analysis assumes that the main and auxiliary paths operate in current mode and combine LSB signals from the main and auxiliary paths to cancel 3H distortion components. The desired LSB output (M) for the main path is represented as:

$${Y}_{RF , MAIN} ( t ) = {Y}_{MAIN , I} ( t ) cos ( {ω}_{LO} t ) + {Y}_{MAIN , Q} ( t ) sin ( {ω}_{LO} t ) , which is further represented as :$$

$${Y}_{R F , M A I N} ( t ) = [ {α}_{1 e} A + ( 3 / 4 ) {α}_{3 e} {A}^{3} ] cos \{ ( {ω}_{LO} - {ω}_{bb} ) t + θ \} + {α}_{3 e} ( 3 / 4 ) {A}^{3} cos \{ ( {ω}_{LO} + 3 {ω}_{bb} ) t + 3 θ \} .$$

Next, the desired LSB output for the auxiliary path can be created in two ways. For example, in some embodiments, a first LSB output (A1) for the auxiliary path can be represented as:

$${Y}_{RF , AUX} ( t ) = {Y}_{AUX , I} ( t ) sin ( {ω}_{LO} t ) - {Y}_{AUX , Q} ( t ) cos ( {ω}_{LO} t ) , which is further represented as :$$

$${Y}_{RF , AUX} ( t ) = [ {α}_{1 c} A + ( 3 / 4 ) {α}_{3 c} {A}^{3} ] sin \{ ( {ω}_{LO} - {ω}_{bb} ) t + φ \} + {α}_{3 c} ( 3 / 4 ) {A}^{3} sin \{ ( {ω}_{LO} + 3 {ω}_{bb} ) t + 3 φ \} .$$

In other embodiments, a second LSB output (A2) for the auxiliary path can be represented as:

$${Y}_{RF , AUX} ( t ) = {Y}_{AUX , I} ( t ) cos ( {ω}_{LO} t ) + {Y}_{AUX , Q} ( t ) sin ( {ω}_{LO} t ) , which is further represented as :$$

$${Y}_{RF , AUX} ( t ) = [ {α}_{1 c} A + ( 3 / 4 ) {α}_{3 c} {A}^{3} ] cos \{ ( {ω}_{LO} - {ω}_{bb} ) t + φ \} + {α}_{3 c} ( 3 / 4 ) {A}^{3} cos \{ ( {ω}_{LO} + 3 {ω}_{bb} ) t + 3 φ \} .$$

The fundamental sideband component in the output signal from the auxiliary path is much smaller than the corresponding fundamental sideband component in the output signal from the main path (e.g., smaller by 12 dB-15 dB, or so). Considering H3 cancellation, and based on the corresponding phase shifts θ and φ, several configurations are possible, when the main path and the auxiliary path having different types of nonlinearity characteristics, wherein, e.g., the main path is expansive and the auxiliary path is compressive. For example, assume (without loss of generality) that the phase shift θ=0 such that the value of φ represents the phase difference between θ and φ, the following configurations as shown in Table 2 are possible:

TABLE 2

| Phase Difference | Configuration | LO Phase Shift | RF Phase Shift |
|---|---|---|---|
| φ~0° | M + A2 | Not needed | Not needed |
| φ~30° | M + A1 | Not needed | Not needed |
| φ~60° | M − A2 | Not needed | Not needed |
| φ~90° | M − A2 | Not needed | Not needed |

On the other hand, assuming (without loss of generality) that the phase shift θ=0 such that the value of φ represents the phase difference between θ and φ, the following configurations as shown in Table 3 are possible when the value of φ is arbitrary:

TABLE 3

| Phase Difference | Configuration | LO Phase Shift | RF Phase Shift |
|---|---|---|---|
| φ~arbitray | M ± A1 | Can be used | Not needed |
| φ~arbitray | M ± A1 | Not needed | Can be used |
| φ~arbitray | M ± A2 | Can be used | Not needed |
| φ~arbitray | M ± A2 | Not needed | Can be used |

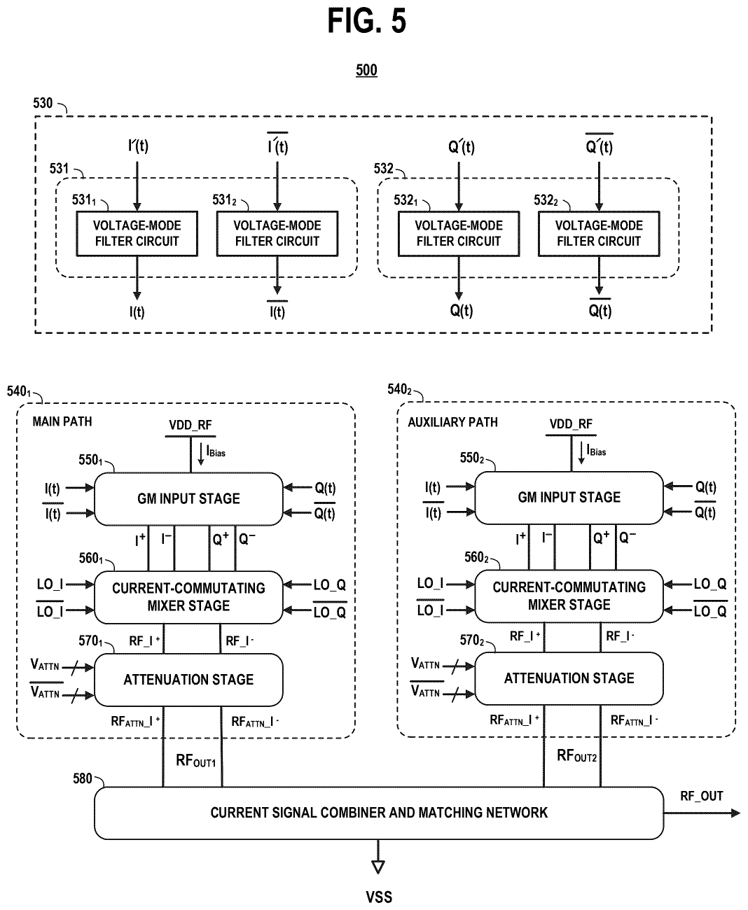

Next, FIG. 5 schematically illustrates an RF signal generator system which is configured to generate radio frequency signals with suppressed harmonic distortion, according to another exemplary embodiment of the disclosure. In particular, FIG. 5 schematically illustrates an exemplary embodiment of an RF signal generator 500 which comprises a differential signal framework, in which complementary quadrature LO signals are utilized to perform I/Q modulation. The complementary quadrature LO signals include in-phase LO signals, LO_I and L̅O̅_̅I̅, and complementary quadrature-phase LO signals, LO_Q and L̅O̅_̅Q̅. Ideally, the complementary quadrature LO signals LO_I, LO_Q, L̅O̅_̅I̅, and L̅O̅_̅Q̅ have the same amplitude and center frequency, but different phases of 0°, 90°, 180°, and 270°, respectively.

As schematically illustrated in FIG. 5, the RF signal generator 500 comprises a baseband filter stage 530, a first RF signal path 540₁ (alternatively, main path 540₁), a second RF signal path 540₂ (alternatively, auxiliary path 540₂), and a current signal combiner and matching network 580. The main path 540₁ comprises a transconductance (gm) baseband input stage 550₁, a mixer stage 560₁, and an attenuation stage 570₁. Similarly, the auxiliary path 540₂ comprises a transconductance (gm) baseband input stage 550₂, a mixer stage 560₂, and an attenuation stage 570₂. The main path 540₁ and the auxiliary path 540₂ comprise RF signal generation paths that are coupled in parallel between an output of the baseband filter stage 530 and an input of the current signal combiner and matching network 580.

In some embodiments, the baseband filter stage 530 implements voltage-mode filter circuitry. In particular, the baseband filter stage 530 comprises a first differential voltage-mode filter 531 and a second differential voltage-mode filter 532. The first differential voltage-mode filter 531 comprises a first voltage-mode filter circuit 531₁, and a second voltage-mode filter circuit 531₂. The second differential voltage-mode filter 532 comprises a first voltage-mode filter circuit 532₁, and a second voltage-mode filter circuit 532₂. In some embodiments, the first differential voltage-mode filter 531 comprises a differential analog low-pass filter, wherein the first voltage-mode filter circuit 531₁, and the second voltage-mode filter circuit 531₂ are configured to receive and filter respective complementary in-phase baseband signals I′(t) and I̅′̅(̅t̅)̅, and output filtered complementary in-phase baseband signals I(t) and I̅(̅t̅)̅. Similarly, in some embodiments, the second differential voltage-mode filter 532 comprises a differential analog low-pass filter, wherein the first voltage-mode filter circuit 532₁, and the second voltage-mode filter circuit 532₂ are configured to receive and filter respective complementary quadrature-phase baseband signals Q′(t) and Q̅′̅(̅t̅)̅, and output filtered complementary quadrature-phase baseband signals Q(t) and Q̅(̅t̅)̅. In some embodiments, the voltage-mode filter circuits 531₁, 531₂, 532₁, and 532₂ each comprise an analog biquadratic low-pass filter circuit which utilizes a unity gain source follower circuit (e.g., a single-transistor Sallen-Key filter architecture).

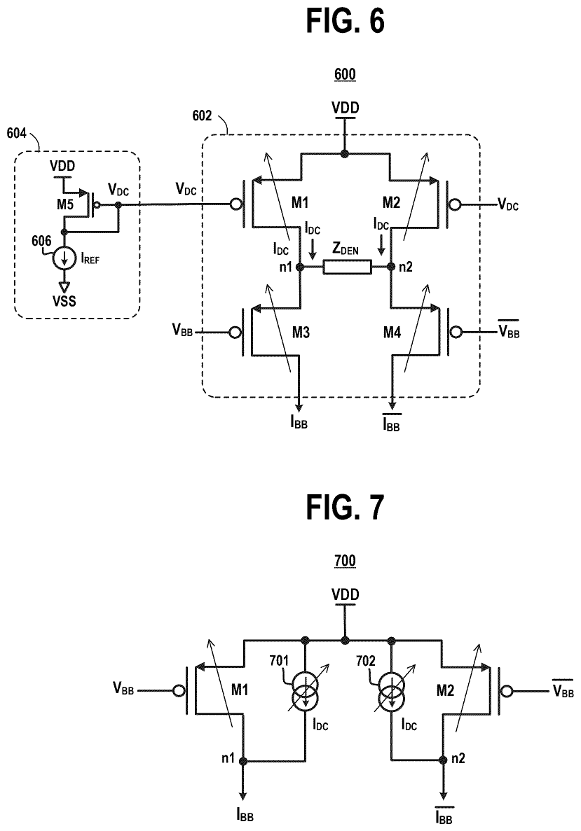

In some embodiments, transconductance baseband input stages 550₁ and 550₂ comprise voltage-mode or current-mode transconductance baseband input stages, and which are configured to compressive nonlinearity or expansive nonlinearity. In some embodiments, the transconductance baseband input stages 550₁ and 550₂ are implemented using voltage-mode or current-mode baseband input stage architecture as will be discussed in further detail below in conjunction with FIGS. 6 and 7.

In some embodiments, the mixer stages 560₂ and 560₂, and the attenuation stages 570₁ and 570₂ implement a current-mode architecture in which the signal processing is performed using time-varying current signals that are generated by the transconductance baseband input stages 550₁ and 550₂ and injected into I/Q signal paths (I⁺, I⁻, Q⁺, and Q⁻) to perform I/Q modulation and upconversion. The transconductance baseband input stages 550₁ and 550₂ are each configured to convert the complementary in-phase voltage baseband signals I(t) and I̅(̅t̅)̅ and complementary quadrature-phase baseband voltage signals Q(t) and Q̅(̅t̅)̅, which are output from the respective first and second differential voltage-mode filters 531 and 532, into time varying analog I/Q current signals that are applied to the I/Q signal paths I⁺, I⁻, Q⁺, and Q⁻.

In some embodiments, the mixer stages 560₁ and 560₂ comprise current-commutating mixer stages that are configured to perform analog I/Q modulation and upconversion from baseband to RF frequencies. As shown in FIG. 5, the each current-commutating mixer stage 560₁ and 560₂ is configured to receive complementary in-phase LO signals LO_I and L̅O̅_̅I̅ and complementary quadrature-phase LO signals LO_Q and L̅O̅_̅Q̅. In some embodiments, each current-commutating mixer stage 560₁ and 560₂ comprises a differential I mixer circuit and a differential Q mixer circuit. The differential I mixer circuit comprises LO inputs which receive the complementary in-phase LO signals LO_I and L̅O̅_̅I̅, and the differential Q mixer circuit comprises LO inputs which receive the complementary quadrature-phase LO signals LO_Q and L̅O̅_̅Q̅. The differential I and Q mixer circuits receive as input the analog I/Q current signals on the signal paths I⁺, I⁻, Q⁺, and Q⁻ and perform mixing/modulation operations to generate time-varying output current signals which are summed/subtracted to achieve the SSB I/Q modulation and generate an RF output signal, e.g., differential RF current signals RF_I⁺ and RF_I⁻.

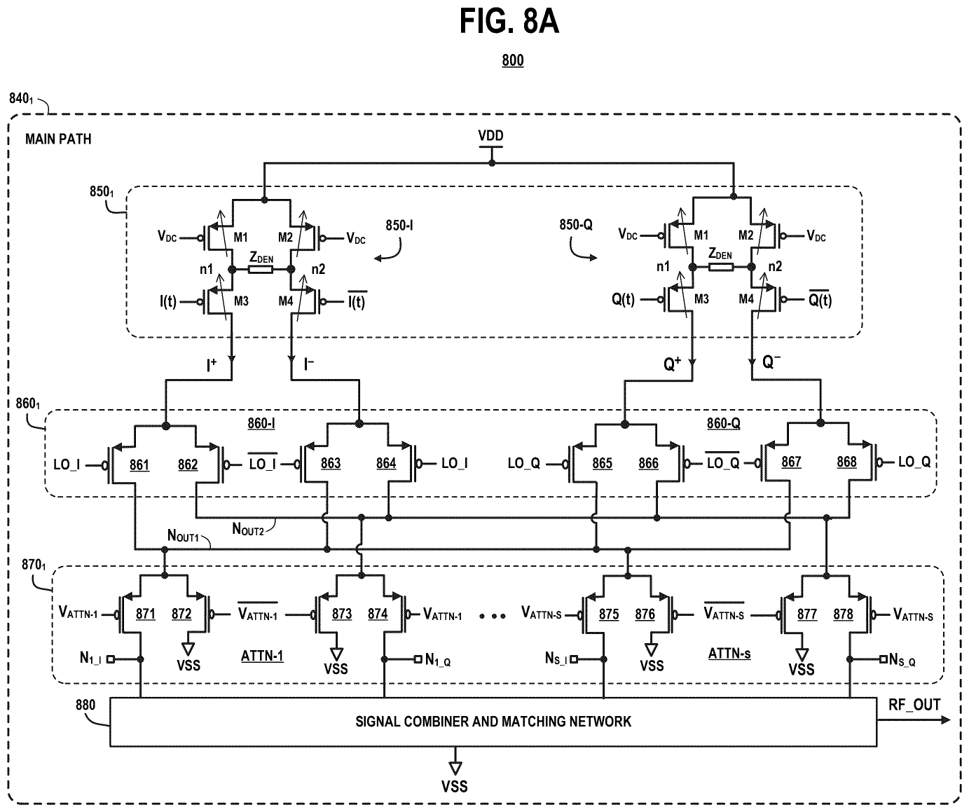

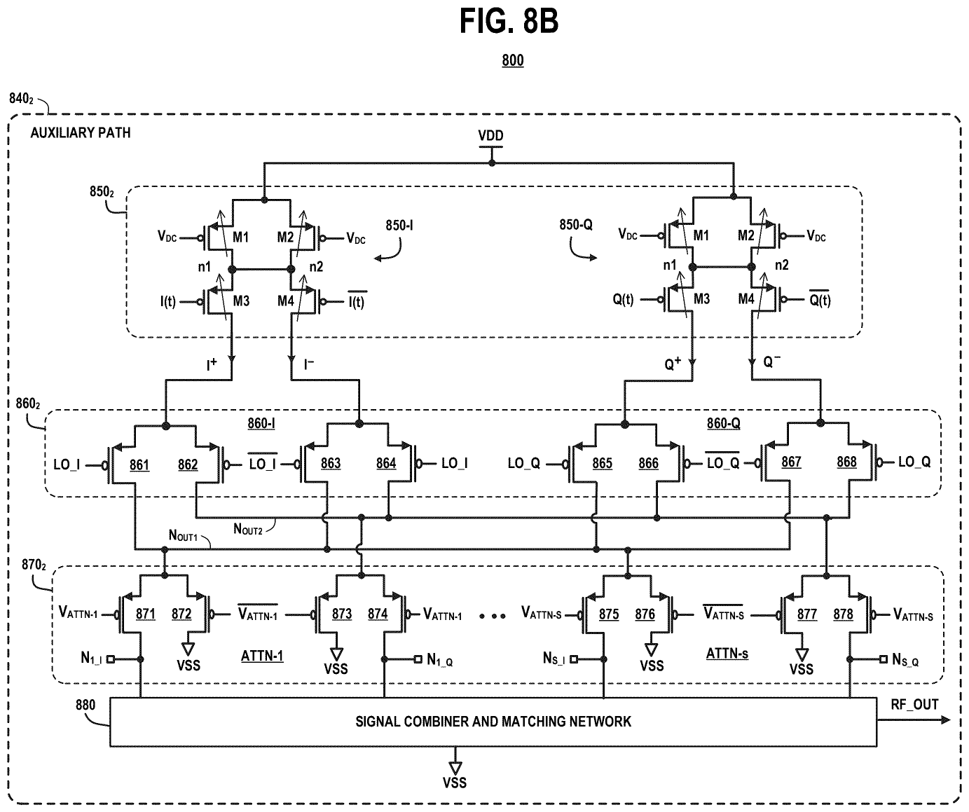

The attenuation stages 570₁ and 570₂ are each configured to adjust a signal strength of the differential RF current signals RF_I⁺ and RF_I⁻ based on a digital attenuation code specified by differential multi-bit attenuation control signals V_{ATTN} and V̅_̅{̅A̅T̅T̅N̅}̅. More specifically, in some embodiments, each attenuation stage 570₁ and 570₂ is configured to adjust the magnitudes of differential RF current signals RF_{ATTN}_I⁺ and RF_{ATTN}_I⁻ that flow to the current signal combiner and matching network 580. The RF_{ATTN}_I⁺ and RF_{ATTN}_I⁻ signals output from the attenuation stage 570₁ in the main path 540₁ provide a first differential RF output signal RF_{OUT1}, while the RF_{ATTN}_I⁺ and RF_{ATTN}_I⁻ signals output from the attenuation stage 570₂ in the auxiliary path 540₂ provide a second differential RF output signal RF_{OUT2}. It is to be noted that exemplary circuit architectures of the current-commutating mixer stages 560₁ and 560₂ and the attenuation stages 570₁ and 570₂ will be discussed in further detail below in conjunction with FIGS. 8A and 8B.

The current signal combiner and matching network 580 is configured to combine (via current combining) the first and second RF output signals RF_{OUT1} and RF_{OUT2} (e.g., RF_{OUT1}−RF_{OUT2}) to generate a differential output signal. The current signal combiner and matching network 580 comprises an output transformer stage with circuitry that is configured to convert the differential output signal into a single-ended output signal RF_OUT. The output transformer stage can be implemented using various techniques and circuit configurations for transforming a differential output signal to a single-ended output signal, which are suitable for the given application and which are well known to those of ordinary skill in the art.

FIG. 6 schematically illustrates a circuit which can be utilized to implement a baseband input stage of an RF signal generator, according to an exemplary embodiment of the disclosure. More specifically, FIG. 6 schematically illustrates an exemplary embodiment of a voltage-mode baseband input stage 600 which comprises a transistor stack 602 and a current reference circuit 604. The transistor stack comprises a plurality of transistors M1, M2, M3, and M4, and a degeneration resistor Z_{DEN}, wherein the transistors M1, M2, M3, and M4 comprise p-type metal-oxide-semiconductor (PMOS) transistors. The current reference circuit 604 comprises a PMOS transistor M5 and a constant current source 606 which generates a reference current I_{REF}.

The transistors M1 and M2 comprise current biasing transistors that are configured to generate a static bias current I_{DC} in each of complementary baseband signal paths I_{BB} and I̅_̅{̅B̅B̅}̅ based on a bias voltage V_{DC} that is commonly applied to gate terminals of the transistors M1 and M2. The current reference circuit 604 is configured to generate the bias voltage V_{DC} which is commonly applied to the gate terminals of gate terminals of the transistors M1 and M2. In this configuration, the current reference circuit 604 and the transistors M1 and M2 form a current mirror circuit, wherein the PMOS transistor M5 comprises a reference transistor and the transistors M1 and M2 comprise mirror transistors of a current mirror circuit, and wherein the transistor M1 and M2 each generate a bias current I_{DC} in proportion (e.g., 1:1 ratio, or greater) to the reference current I_{REF} of the current reference circuit 604 (e.g., I_{REF}=I_{DC}).

The transistors M3 and M4 comprise a differential transistor pair, which have respective source terminals that are coupled to respective drain terminals of transistors M1 and M2 at nodes n1 and n2. The degeneration resistor Z_{DEN} is coupled to and between the nodes n1 and n2. The transistors M3 and M4 comprise respective gate terminals which receive complementary baseband voltage signals V_{BB} and V̅_̅{̅B̅B̅}̅ respectively. In the context of the exemplary RF signal generators discussed herein, the baseband voltage signals V_{BB} and V̅I̅_̅{̅B̅B̅}̅ can be complementary baseband signals I(t) and I̅(̅t̅)̅ or Q(t) and Q̅(̅t̅)̅), which are output from differential voltage-mode filters (such as shown in FIG. 5).

The voltage-mode baseband input stage 600 can be configured to have an expansive nonlinear response or a compressive nonlinear response. For example, the voltage-mode baseband input stage 600 can be configured to have an expansive nonlinear response by setting V_{DC}=0V. On the other hand, the voltage-mode baseband input stage 600 can be configured to have a moderate compressive nonlinear response by setting V_{DC} (via the current reference circuit 604) to a value V_{DC}>0V. Moreover, the voltage-mode baseband input stage 600 can be configured to have a highly compressive nonlinear response by setting Z_{DEN} close to zero Ohms (e.g., shorting the nodes n1 and n2). In addition, a phase shift can be achieved by programmatically adjusting a value of Z_{DEN}.

It is to be noted that in some embodiments, the transistors M1, M2, M3, and M4 of the transistor stack 602 comprise variable gain elements (as schematically illustrated by the slanted arrows across the transistors) which are configurable to adjust the baseband signal gain in the complementary baseband signal paths. For example, in some embodiments, each transistor M1 and M2 comprises a variable-width transistor that is structurally configured and controlled using known techniques to vary the effective gate width of the transistor structure and, thus, adjust a maximum amount of DC bias current I_{DC} (e.g., quiescent current) that flows through the baseband input transistors M3 and M4 when operating in saturation mode. Moreover, the baseband input transistors M3 and M4 comprise a variable-width transistor that is structurally configured and controlled using known techniques to vary the effective gate width of the transistor structure and, thus, enable transconductance (gm) tuning,

$${g}_{m} = \frac{Δ {I}_{O U T}}{{Δ V}_{IN}} ,$$

in the voltage-mode baseband signal input stage 600.

In some embodiments, each transistor M1, M2, M3, and M4 can be structurally configured to include a plurality of transistor segments that are coupled in parallel, wherein the number of segments that are active/inactive at a given time (via a digital switching control system) can be adjusted to change the effective gate width of a given transistor. In this regard, the effective widths of the transistors M1, M2, M3, and M4 can be configured to adjust the baseband signal gain in the complementary baseband signal paths over a target gain range (e.g., gain range of 20 dB) with multiple gain step settings within the gain range. In this manner, the voltage-mode baseband input stage 600 can be configured to have programmable distortion levels depending on the current density the voltage-mode baseband input stage 600, wherein the current density is adjusted by changing the effective widths of the transistors M1 and M2, or M3 and M4.

FIG. 7 schematically illustrates a circuit which can be utilized to implement a baseband input stage of an RF signal generator, according to another exemplary embodiment of the disclosure. More specifically, FIG. 7 schematically illustrates an exemplary embodiment of a current-mode baseband input stage 700 which comprises a differential pair of baseband input transistors M1 and M2, a first variable current source 701, and a second variable current source 702. The baseband input transistors M1 and M2 comprise PMOS transistors having respective gate terminals which receive complementary baseband voltage signals V_{BB} and V̅_̅{̅B̅B̅}̅ respectively. In the context of the exemplary RF signal generators discussed herein, the baseband voltage signals V_{BB} and V̅_̅{̅B̅B̅}̅ can be complementary baseband signals I(t) and I̅(̅t̅)̅ or Q(t) and Q̅(̅t̅)̅), which are output from differential voltage-mode filters (such as shown in FIG. 5).

The first variable current source 701 is configured to inject a DC bias current I_{DC} into node n1, and the second variable current source 702 is configured to inject a DC bias current I_{DC} into node n2, to thereby DC bias the complementary baseband signal paths I_{BB} and I̅_̅{̅B̅B̅}̅. In this configuration, the total amount of current in each of the complementary baseband signal paths I_{BB} and I̅_̅{̅B̅B̅}̅ is equal to a dynamic current I_{DYN} plus the DC bias current I_{DC}, wherein the dynamic current I_{DYN} in the complementary baseband signal paths I_{BB} and I̅_̅{̅B̅B̅}̅ varies based on the complementary baseband voltage signals V_{BB} and V̅_̅{̅B̅B̅}̅ applied to the respective gate terminals of the transistors M1 and M2.

It is to be noted that the current-mode baseband input stage 700 provides no clear boundary between expansive or compressive nonlinear responses. However, the signal-to-noise-and-distortion ratio (SNDR) of the current-mode baseband input stage 700 can be tuned as desired by adjusting the ratio of the dynamic current I_{DYN} to the DC bias current I_{DC}, i.e., I_{DYN}/I_{DC}. Moreover, the DC bias current I_{DC} can be programmed to configure the current-mode baseband input stage 700 to have one of a plurality of different classes of operation (A/B/AB, etc.) by changing the conduction angle.

FIGS. 8A and 8B schematically illustrate a radio frequency signal generator system which is configured to generate radio frequency signals with suppressed harmonic distortion, according to another exemplary embodiment of the disclosure. In particular, FIGS. 8A and 8B schematically illustrate an exemplary embodiment of an RF signal generator 800 which comprises a differential signal framework, in which complementary quadrature LO signals are utilized to perform I/Q modulation. FIGS. 8A and 8B schematically illustrate a main path 840₁ and an auxiliary path 840₂, respectively, of an RF signal generator comprising a complementary quadrature LO signal architecture. In particular, FIGS. 8A and 8B schematically illustrate an exemplary architecture of an RF signal generator in which the main path 840₁ (FIG. 8A) and the auxiliary path 840₂ (FIG. 8B) have a complementary quadrature LO signal architecture based on that shown in FIG. 5, and with transconductance baseband input stages implemented based on the exemplary architecture of the voltage-mode baseband input stage 600 of FIG. 6.

As schematically illustrated in FIG. 8A, the main path 840₁ comprises a transconductance (gm) baseband input stage 850₁, a mixer stage 860₁, and an attenuation stage 870₁. Similarly, as schematically illustrated in FIG. 8B, the auxiliary path 840₂ comprises a transconductance (gm) baseband input stage 850₂, a mixer stage 860₂, and an attenuation stage 870₂. The attenuation stages 870₁ and 870₂ have outputs that are coupled to a signal combiner and matching network 880. For case of illustration and discussion, the DAC and filter stages of the RF signal generator 800 are not shown in FIGS. 8A and 8B.

Referring to FIG. 8A, the transconductance baseband input stage 850₁ comprises a first voltage-mode baseband input stage 850-I (for the baseband I-phase), and a second voltage-mode baseband input stage 850-Q (for the baseband Q phase). The first and second voltage-mode baseband input stages 850-I and 850-Q have circuit architectures that are the same or similar to that discussed above in conjunction with FIG. 6, the details of which will not be repeated. The baseband input transistors M3 and M4 (differential pair) of the first voltage-mode baseband input stage 850-I have respective gate terminals which receive complementary baseband voltage signals I(t) and I̅(̅t̅)̅, respectively (which may be generated by differential voltage-mode filter circuits, as shown in FIG. 5). The baseband input transistors M3 and M4 (differential pair) of the second voltage-mode baseband input stage 850-Q have respective gate terminals which receive complementary baseband voltage signals Q(t) and Q̅(̅t̅)̅, respectively (which may be generated by differential voltage-mode filter circuits, as shown in FIG. 5). The first voltage-mode baseband input stage 850-I generates currents that are applied to I/Q signal paths, I⁺ and I⁻. The second voltage-mode baseband input stage 850-Q generates currents that are applied to I/Q signal paths Q⁺ and Q⁻. The static DC baseband currents in the I/Q signal paths I⁺, I⁻, Q⁺, and Q⁻ are generated by the transistors M1 and M2, while the dynamic currents in the respective I/Q signal paths I⁺, I⁻, Q⁺, and Q⁻ are generated by the transistors M3 and M4.

The mixer stage 860₁ is a current-commutating mixer stage which comprises a differential I mixer 860-I, and a differential Q mixer 860-Q. The differential I mixer 860-1 comprises a plurality of mixing transistors 861, 862, 863, and 864 (alternatively, I mixer switching transistors 861, 862, 863, and 864). The differential Q mixer 860-Q comprises mixing transistors 865, 866, 867, and 868 (alternatively, Q mixer switching transistors 865, 866, 867, and 868). In some embodiments, as shown in FIG. 8A, the mixing transistors 861, 862, 863, 864, 865, 866, 867, and 868 are PMOS transistors. In some embodiments, the mixing transistors 861, 862, 863, 864, 865, 866, 867, and 868 are biased to operate in triode mode.

In the differential I mixer 860-I, the mixing transistors 861 and 862 comprise a first differential mixer transistor pair having source terminals that are commonly connected to the drain terminal of the transistor M3 of the first voltage-mode baseband input stage 850-I, and respective gate terminals which receive as input the complementary in-phase LO signals LO_I and L̅O̅_̅I̅, respectively. The mixing transistors 863 and 864 comprise a second differential mixer transistor pair having source terminals that are commonly connected to the drain terminal of the transistor M4 of the first voltage-mode baseband input stage 850-I, and respective gate terminals which receive as input the complementary in-phase LO signals LO_I and L̅O̅_̅I̅, respectively.

In the differential Q mixer 860-Q, the mixing transistors 865 and 866 comprise a first differential mixer transistor pair having source terminals that are commonly connected to the drain terminal of the transistor M3 of the second voltage-mode baseband input stage 850-Q, and respective gate terminals which receive as input the complementary quadrature-phase LO signals LO_Q and L̅O̅_̅Q̅, respectively. The mixing transistors 867 and 868 comprise a second differential mixer transistor pair having source terminals that are commonly connected to the drain terminal of the transistor M4 of the second voltage-mode baseband input stage 850-Q, and respective gate terminals which receive as input the complementary quadrature-phase LO signals L̅O̅_̅Q̅ and LO_Q, respectively.

The current-commutating mixer stage 860₁ comprises two output nodes, denoted N_{OUT1} and N_{OUT2}. As schematically shown in FIG. 8A, the mixing transistors 861, 863, 865, and 867 have drain terminals that are commonly coupled to the output node N_{OUT1} of the current-commutating mixer stage 860₁, and the mixing transistors 862, 864, 866, and 868 have drain terminals that are commonly coupled to the output node N_{OUT2} of the current-commutating mixer stage 860. The differential I mixer 860-I and the differential Q mixer 860-Q are configured to provide analog I/Q modulation and upconversion, where the connections of the mixing transistors of the differential I and Q mixers 860-1 and 860-Q (operating in triode mode) allow for the summation/subtraction of the output currents of the mixing transistors 861, 862, 863, 864, 865, 866, 867, and 868 to achieve the SSB I/Q modulation, as is understood by those of ordinary skill in the art.

The attenuation stage 870₁ is configured to adjust a signal strength of the RF output signal, RF_OUT. More specifically, in the exemplary embodiment of FIG. 8A, the attenuation stage 870₁ is configured to adjust the amount of differential current that flows from the output nodes N_{OUT1} and N_{OUT2} to the signal combiner and matching network 880. In this regard, the attenuation stage 870₁ is configured to adjust the signal level of the signal output from the current-commutating mixer stage 860. The attenuation stage 870₁ comprises a plurality of attenuation segments ATTN-1, . . . , ATTN-S which are digitally controlled by respective pairs of differential control signals [V_{ATTN-1}, V̅_̅{̅A̅T̅T̅N̅-̅1̅}̅], . . . [V_{ATTN-S}, V̅_̅{̅A̅T̅T̅N̅-̅S̅}̅]. As schematically illustrated in FIG. 8A, the first attenuation segment ATTN-1 comprises a first differential pair of transistors 871 and 872, and a second differential pair of transistors 873 and 874. In addition, the attenuation segment ATTN-S comprises a first differential pair of transistors 875 and 876, and a second differential pair of transistors 877 and 878. In some embodiments, the transistors 871, 872, 873, 874, 875, 876, 877, and 878 of the attenuation stage 870₁ are PMOS transistors. The number(S) of attenuation segments ATTN-1, . . . , ATTN-S that are implemented will depend on the desired resolution of gain adjustment.

In the first attenuation segment ATTN-1, the first differential pair of transistors 871 and 872 have source terminals that are commonly connected to the mixer output node N_{OUT1}, and gate terminals that receive as input the differential control signals V_{ATTN-1} and V̅_̅{̅A̅T̅T̅N̅-̅1̅}̅, respectively. The transistor 871 has a drain terminal that is coupled to the signal combiner and matching network 880, and the transistor 872 has a drain terminal that is coupled to a negative power supply node VSS (e.g., 0V ground voltage). In addition, the second differential pair of transistors 873 and 874 have source terminals that are commonly connected to the mixer output node N_{OUT2}, and gate terminals that receive as input the differential control signals V̅_̅{̅A̅T̅T̅N̅-̅1̅}̅ and V_{ATTN-1}, respectively. The transistor 873 has a drain terminal that is coupled to the negative power supply node VSS, and the transistor 874 has a drain terminal that is coupled to the signal combiner and matching network 880.

Similarly, in the attenuation segment ATTN-S, the first differential pair of transistors 875 and 876 have source terminals that are commonly connected to the mixer output node N_{OUT1}, and gate terminals that receive as input the differential control signals V_{ATTN-S} and V̅_̅{̅A̅T̅T̅N̅-̅S̅}̅, respectively. The transistor 875 has a drain terminal that is coupled to the signal combiner and matching network 880, and the transistor 876 has a drain terminal that is coupled to the negative power supply node VSS. In addition, the second differential pair of transistors 877 and 878 have source terminals that are commonly connected to the mixer output node N_{OUT2}, and gate terminals that receive as input the differential control signals V̅_̅{̅A̅T̅T̅N̅-̅S̅}̅ and V_{ATTN-S}, respectively. The transistor 877 has a drain terminal that is coupled to the negative power supply node VSS, and the transistor 878 has a drain terminal that is coupled to the signal combiner and matching network 880.

In operation, the amount of differential current that flows from the output nodes N_{OUT1} and N_{OUT2} to the signal combiner and matching network 880, can be adjusted based on the number of attenuation segments ATTN-1, . . . , ATTN-S that are activated. A given attenuation segment is “activated” when the corresponding differential control signals V_{ATTN} and V̅_̅{̅A̅T̅T̅N̅}̅ are logic “0” and logic “1”, respectively. For instance, the first attenuation segment ATTN-1 will be activated when V_{ATTN-1} is logic “0” and V̅_̅{̅A̅T̅T̅N̅-̅1̅}̅ is logic “1” such that the transistors 871 and 874 will be in a turned “On” state and allow some current to flow from the output nodes N_{OUT1} and N_{OUT2} to the signal combiner and matching network 880, while the transistors 872 and 873 will be in a turned “Off state. On the other hand, the first attenuation segment ATTN-1 will be “deactivated” when V_{ATTN-1} is logic “1” and V̅_̅{̅A̅T̅T̅N̅-̅1̅}̅ is logic “0” such that the transistors 871 and 874 will be in a turned “Off” state, and the transistors 872 and 873 will be in a turned “On” state and allow some current to flow from the output nodes N_{OUT1} and N_{OUT2} to the negative power supply node VSS (e.g., ground). Since the current flowing from the output nodes N_{OUT1} and N_{OUT2} to the negative power supply node VSS (e.g., ground) does not contribute to the current flowing through the signal combiner and matching network 880, the RF output signal level is reduced.

In this configuration, the amount of differential current that flows from the output nodes N_{OUT1} and N_{OUT2} to the signal combiner and matching network 880 can be increased by increasing the number of activated attenuation segments, or decreased by decreasing the number of activated attenuation segments. The number(S) of attenuation segments ATTN-1, . . . , ATTN-S that are implemented will depend on the desired resolution of gain adjustment. It is to be noted that when activated, the transistors of the attenuation stage 870₁ are configured to operate in saturation mode.

It is to be noted that the auxiliary path 840₂ shown in FIG. 8B has the same circuit architecture and modes of operation as the main path 840₁ shown in FIG. 8A. However, as shown in FIG. 8B, the transconductance baseband input stage 850₂ in the auxiliary path 840₂ differs from the transconductance baseband input stage 850₁ in the main path 840₁ in that first and second voltage-mode baseband input stages 850-I and 850-Q do not include degeneration resistors. Instead, as shown in FIG. 8B, the nodes n1 and n2 each of the first and second voltage-mode baseband input stages 850-I and 850-Q are shorted. In this configuration, the transconductance baseband input stage 850₂ in the auxiliary path 840₂ is configured to generate higher distortion for purposes of enabling the cancellation (or suppression) of harmonic distortion in a resulting RF output signal, as discussed above.

As further shown in FIGS. 8A and 8B, the drain terminals of the transistors 871 of the attenuation segments ATTN-1 of the attenuation stages 870₁ and 870₂ of the main and auxiliary paths 840₁ and 840₂ (and other auxiliary paths, if present) are commonly coupled to an output node N_{1_I}. Moreover, the drain terminals of the transistors 874 of the attenuation segments ATTN-1 of the attenuation stages 870₁ and 870₂ of the main and auxiliary paths 840₁ and 840₂ (and other auxiliary paths, if present) are commonly coupled to an output node N_{1_Q}. Similarly, the drain terminals of the transistors 875 of the attenuation segments ATTN-S of the attenuation stages 870₁ and 870₂ of the main and auxiliary paths 840₁ and 840₂ (and other auxiliary paths, if present) are commonly coupled to an output node N_{S_I}. Moreover, the drain terminals of the transistors 878 of the attenuation segments ATTN-S of the attenuation stages 870₁ and 870₂ of the main and auxiliary paths 840₁ and 840₂ (and other auxiliary paths, if present) are commonly coupled to an output node N_{S_Q}. In this exemplary configuration, the output currents of corresponding attenuation segments ATTN-1, . . . , ATTN-S the attenuation stages 870₁ and 870₂ of the main and auxiliary paths 840₁ and 840₂ (and other auxiliary paths, if present) are combined at the respective nodes N_{1_I}/N_{1_Q}, . . . , N_{S_1}/N_{S_Q} before being input to the signal combiner and matching network 880.

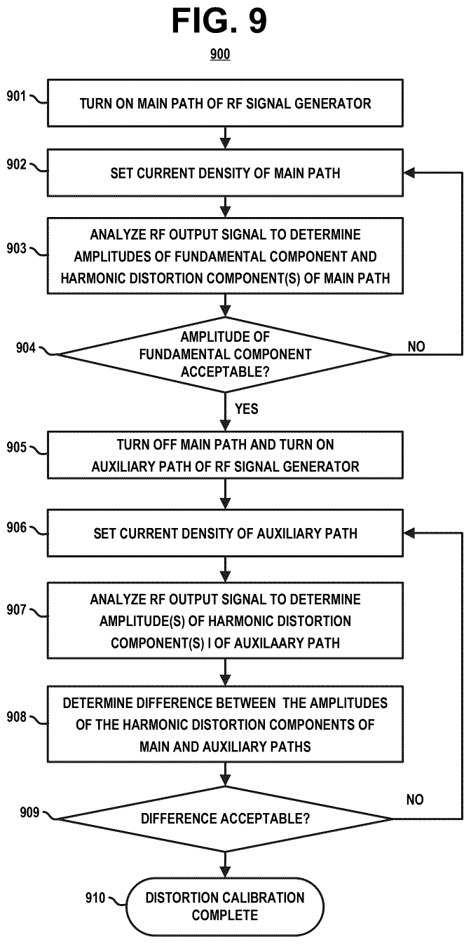

FIG. 9 illustrates a flow diagram of a method to perform distortion calibration in radio frequency signal generator to suppress harmonic distortion, according to another exemplary embodiment of the disclosure. In particular, in some embodiments, FIG. 9 illustrates a distortion calibration process 900 which can be implemented by a calibration control system upon, e.g., startup of an RF signal generator having a main RF path and one auxiliary RF path, according to an exemplary embodiment of the disclosure. Initially, the main path of the RF signal generator is turned on (block 901), and the calibration process proceeds to set a current density in the main path (block 902). An RF output signal generated by the main path is then analyzed (via spectral analysis) to determine amplitudes of a fundamental frequency component and at least one harmonic distortion component (e.g., 3H frequency component) in the RF output signal generated by the main path (block 903).

A determination is made as to whether the amplitude of the fundamental frequency component is acceptable (block 904). If the amplitude of the fundamental frequency component is deemed unacceptable (negative determination in block 904), the current density of the main path is adjusted (return to block 902), and the spectral analysis in block 903 is repeated. On the other hand, once the amplitude of the fundamental frequency component is deemed acceptable (affirmative determination in block 904), the calibration process proceeds to turn off the main path and turn on the auxiliary path of the RF signal generator (block 905), and set a current density in the auxiliary path (block 906). An RF output signal generated by the auxiliary path is then analyzed (via spectral analysis) to determine an amplitude of at least one harmonic distortion component (e.g., 3H frequency component) in the RF output signal generated by the auxiliary path (block 907).

The calibration process then proceeds to determine a difference between the amplitudes of the harmonic distortion components (e.g., 3H components) in the main and auxiliary paths (block 908). If the determined difference between the amplitudes of the harmonic distortion components is deemed unacceptable (negative determination in block 909), the current density of the auxiliary path is adjusted (return to block 906), and the spectral analysis in block 907 and difference computation in block 908 are repeated. On the other hand, once the difference between the amplitudes of the harmonic distortion components is deemed acceptable (affirmative determination in block 909), the distortion calibration process is deemed complete (block 910).

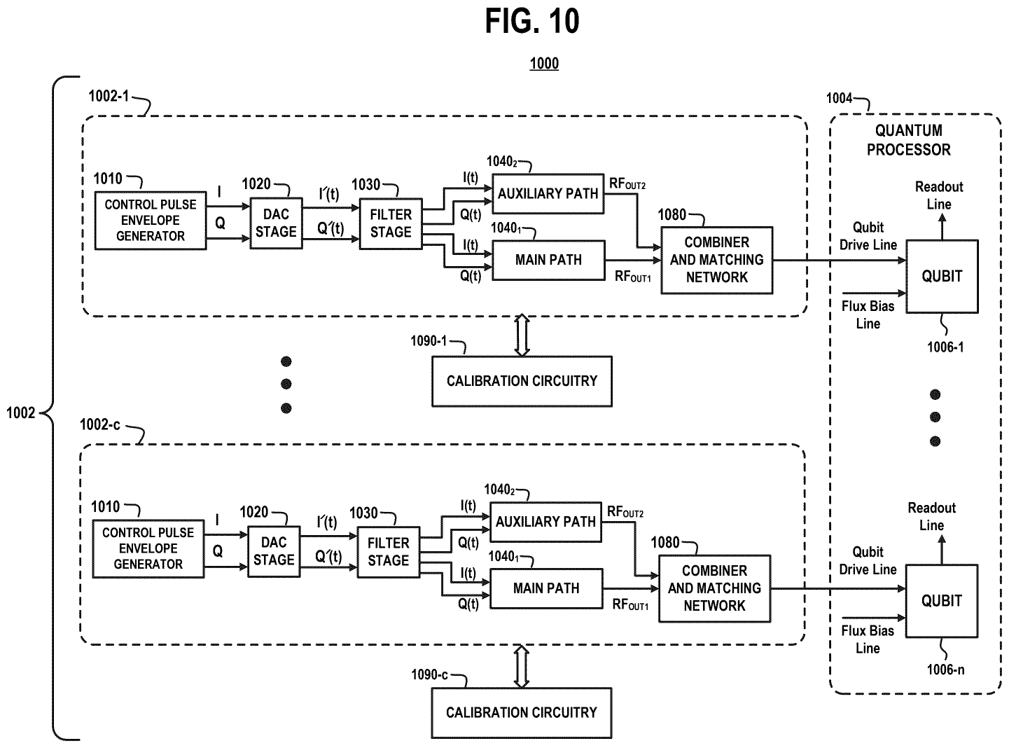

FIG. 10 schematically illustrates a quantum computing system which implements an arbitrary waveform generator system that is configured to generate radio frequency signals with suppressed harmonic distortion, according to an exemplary embodiment of the disclosure. For example, FIG. 10 schematically illustrates a quantum computing system 1000 which implements an arbitrary waveform generator system and calibration circuitry, according to an exemplary embodiment of the disclosure. The quantum computing system 1000 comprises an arbitrary waveform generator system 1002 (or AWG system 1002) and a quantum processor 1004. The quantum processor 1004 comprises a plurality (n) of superconducting qubits 1006-1, . . . , 1006-n. The superconducting qubits 1006-1, . . . , 1006-n may comprise superconducting transmon qubits, superconducting fluxonium qubits, superconducting multi-mode qubits, and other types, or combinations of different types, of superconducting qubits, which are suitable for a given application. Further, in some embodiments, the quantum processor 1004 comprises coupler circuits (e.g., passive coupler circuits and/or active coupler circuits), wherein a given coupler circuit is configured to couple a pair of superconducting qubits to implement entanglement gate operations (e.g., two-qubit gate operations).

The quantum processor 1004 further comprises a plurality of control lines (e.g., transmission line resonators) including, but not limited to, qubit drive lines, flux bias lines, state readout lines, and active coupler drive lines, etc. In some embodiments, the qubit drive lines are coupled (e.g., capacitively coupled) to respective ones of the superconducting qubits 1006-1, . . . . 1006-n. The qubit drive lines are configured to apply control pulses (which are generated by the AWG system 1002) to the respective superconducting qubits 1006-1, . . . , 1006-n to independently change the states of the respective superconducting qubits (e.g., single-qubit gate operations), e.g., change the state of a given superconducting qubit to be in, e.g., a ground state |0 [symbol] , an excited state |1 [symbol] , or a superposition state. As is known in the art, the state of a superconducting qubit can be changed by applying a microwave control pulse with a center frequency that is equal to a transition frequency (denoted f₀₁) of the qubit, wherein the transition frequency f₀₁ corresponds to an energy difference between the ground state |0 [symbol] and excited state |1 [symbol] of the qubit. In some embodiments, the superconducting qubits 1006-1, . . . , 1006-n are configured to have different operating frequencies (transition frequencies) so that the transition frequencies of neighboring qubits are detuned.

The state readout lines are coupled to respective ones of the superconducting qubits 1006-1, . . . , 1006-n to read the states of the superconducting qubits using known techniques (e.g., dispersive readout). In embodiments where the superconducting qubits comprise frequency-tunable qubits (e.g., flux-tunable transmon qubits or fluxonium qubits, etc.), the flux bias control lines would be coupled (e.g., inductively coupled) to respective superconducting qubits to apply flux bias control signals to tuning structures of the superconducting qubits to tune the operating frequencies of the tunable qubits, as needed for a given application. In addition, for active coupler circuits, coupler drive lines would be coupled (e.g., capacitively coupled) to respective coupler circuits, wherein each coupler circuit would have an operating frequency or transition frequency. A given coupler circuit would be driven by a control pulse generated by the AWG system 1002, or some other pulse signal generator, to enable exchange coupling between superconducting qubits that are coupled through the given coupler circuit and implement a two-qubit gate operation.

As shown in FIG. 10, the AWG system 1002 comprises a multi-channel AWG framework which comprises a plurality of AWG channels 1002-1, . . . , 1002-c. The AWG channels 1002-1, . . . , 1002-c are configured to generate control pulses that are applied on the qubit drive lines to control respective ones of the superconducting qubits 1006-1, . . . , 1006-n. Although not specifically shown in FIG. 10, in some embodiments, the AWG system 1002 would include AWG channels to generate control signals that are applied to the coupler drive lines to control active coupler devices of the quantum processor 1004.

In some embodiments, the AWG channels 1002-1, . . . , 1002-c each comprise a respective control pulse envelope generator 1010, a DAC stage 1020, a filter stage 1030, a main RF path 1040₁, an auxiliary path 1040₂, and a signal combiner and matching network 1080. The control pulse envelope generators 1010 are configured to implement pulse-shaping techniques to generate RF control pulses with desired control pulse envelope shapes (e.g., Gaussian pulses, cosine pulses (e.g., sum of half cosines), hyperbolic secant pulses, etc.), which are applied to superconducting qubits or active qubit coupler circuits to perform single qubit gate operations, entanglement gate operations, etc. The shaped control pulses are calibrated to drive f₀₁ transitions of the qubits, while suppressing f₁₂ and higher transitions. Essentially, such pulse shaping techniques suppress/reduce the transients associated with turning the control pulses on and off. In addition, pulse-shaping techniques include DRAG (derivative removal by adiabatic gate) correction pulses, which can be used in conjunction with shaped pulses (such as Gaussian pulses, cosine pulses, or hyperbolic secant pulses) to further suppress unwanted state transitions, while maintaining a same pulse envelope area (or integral of pulse envelope).

In each AWG channel of the AWG system 1002, the digital control pulse envelope signals (digital I and Q components) are converted to analog control pulse envelope signals (analog baseband I/Q signals), and the I/Q mixer stages in each of the main and auxiliary paths 1040₁ and 1040₂ modulates the quadrature LO signals using the baseband I/Q signals by performing, e.g., SSB modulation, as discussed above, to generate respective RF output signals RF_{OUT1} and RF_{OUT2}, which are combined to generate an RF output signal in the form of an RF control pulse that is applied, e.g., on a qubit drive line to control a given qubit. The functions of the various stages 1020, 1030 and 1080, and the stages of the main path 1040₁ and the auxiliary path 1040₂ are the same or similar to the corresponding stages and paths discussed above in any of the exemplary embodiments shown in FIGS. 1, 2A, 2B, 4, 5, 8A and 8B, the details of which will not be repeated.

As further shown in FIG. 10, in some embodiments, each AWG channel 1002-1, . . . , 1002-c of the AWG system 1002 comprises dedicated calibration circuitry 1090-1, . . . , 1090-c, which is implemented on-chip with the AWG system 1002. The calibration circuitry 1090-1, . . . , 1090-c is configured to calibrate the respective AWG channels 1002-1, . . . , 1002-c of the AWG system 1002 for different operating modes, as discussed above, as well as perform distortion calibration control functions as discussed above (e.g., distortion calibration process of FIG. 9). The calibration circuitry 1090-1, . . . , 1090-c comprises the hardware control and logic circuitry as discussed above. In some embodiments, the calibration circuitry 1090-1, . . . , 1090-c is controlled by software running on a computing platform that controls the quantum computing system 1000.

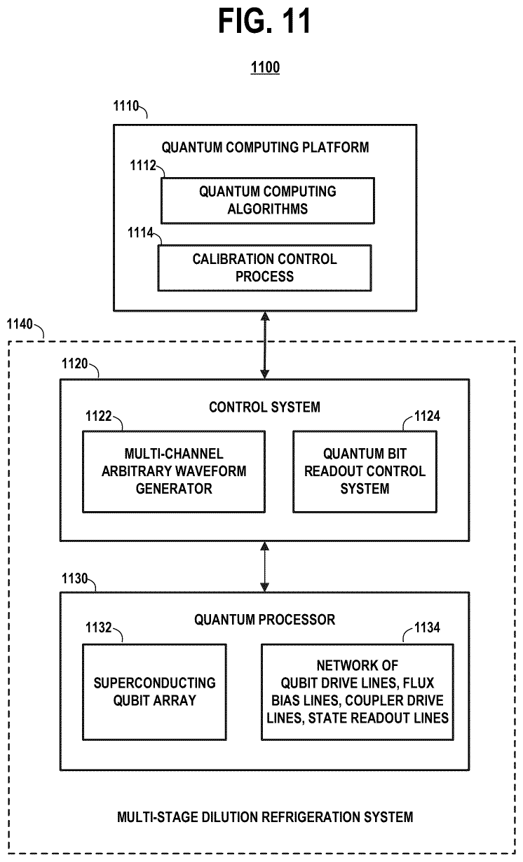

Next, FIG. 11 schematically illustrates a quantum computing system, according to another exemplary embodiment of the disclosure. In particular, FIG. 11 schematically illustrates a quantum computing system 1100 which comprises a quantum computing platform 1110, a control system 1120, and a quantum processor 1130. In some embodiments, the quantum computing platform 1110 implements software programs such as quantum computing algorithms 1112 to perform quantum computing or quantum information process, and a calibration control process 1114 which performs functions such as configuring the AWG system, controlling the execution of high-level functions of the calibration processes, etc.

Furthermore, the quantum computing platform 1110 executes calibration procedures that are periodically performed on a quantum system such as a quantum processor to calibrate various quantum elements such as readout resonators, data qubits, and coupler circuitry, etc., to enable high-fidelity gate operations (e.g., single-qubit gate operations and entanglement gate operations). For example, various types of in-situ calibration procedures are periodically performed to, e.g., determine the resonant frequencies of readout resonators, determine the transition frequencies of qubits, determine coherence times (T₁) of the qubits (where the coherence time T₁ of a given qubit denotes the time it takes for the qubit state to decay from the excited state to the ground state), determine transverse relaxation times (T₂) of the qubits (or dephasing time), calibrate control pulses that are applied to qubits to perform single-qubit gate operations, calibrate control pulses that are applied to active coupler circuits to perform entanglement gate operations, etc. The calibration procedures result in determining various control parameters that are maintained in a calibration database and periodically updated on the order of seconds, minutes, hours, days, etc., as needed, depending on the type of quantum element and the operating characteristics of the quantum computing system, and other factors as is understood by those of ordinary skill in the art.

In some embodiments, the control system 1120 comprises a multi-channel arbitrary waveform generator 1122, and a quantum bit readout control system 1124, wherein FIG. 10 schematically illustrates an exemplary AWG system 1002 which can be implemented in the control system 1120. The quantum processor 1130 comprises one or more quantum processor chips comprising a superconducting qubit array 1132 and a network 1134 of qubit drive lines, coupler drive lines, and qubit state readout lines, and other circuit QED components that may be needed for a given application or quantum system configuration.

In some embodiments, the control system 1120 and the quantum processor 1130 are disposed in a dilution refrigeration system 1140 which can generate cryogenic temperatures that are sufficient to operate components of the control system 1120 for quantum computing applications. For example, the quantum processor 1130 may need to be cooled down to near-absolute zero, e.g., 10-15 millikelvin (mK), to allow the superconducting qubits to exhibit quantum behaviors. In some embodiments, the dilution refrigeration system 1140 comprises a multi-stage dilution refrigerator where the components of the control system 1120 can be maintained at different cryogenic temperatures, as needed. For example, while the quantum processor 1130 may need to be cooled down to, e.g., 10-15 mK, the circuit components of the control system 1120 may be operated at cryogenic temperatures greater than 10-15 mK (e.g., cryogenic temperatures in a range of 3K-4K), depending on the configuration of the quantum computing system.

In some embodiments, the superconducting qubit array 1132 comprises a plurality of superconducting transmon qubits and superconducting tunable coupler qubits, in which each pair of superconducting qubits is connected by a respective superconducting qubit coupler, using techniques as discussed herein. The network 1134 of qubit drive lines, flux bias lines, coupler drive lines, and qubit state readout lines, etc., are configured to apply microwave control signals to superconducting qubits and coupler circuitry in the superconducting qubit array 1132 to perform various types of gate operations, e.g., single-gate operations, entanglement gate operations, etc., as well as read the quantum states of the superconducting qubits. The network 1134 of qubit drive lines, flux bias lines, coupler drive lines, and qubit state readout lines, etc., is coupled to the control system 1120 through a suitable hardware input/output (I/O) interface, which couples I/O signals between the control system 1120 and the quantum processor 1130. For example, the hardware I/O interface may comprise various types of hardware and components, such as RF cables, wiring, RF elements, optical fibers, heat exchanges, filters, amplifiers, isolators, etc.

The quantum computing platform 1110 comprises a software and hardware platform which comprises various software layers that are configured to perform various functions, including, but not limited to, generating and implementing various quantum applications using suitable quantum programming languages, configuring and implementing various quantum gate operations, compiling quantum programs into a quantum assembly language, implementing and utilizing a suitable quantum instruction set architecture (ISA), performing calibration operations to calibrate the quantum circuit elements and gate operations, etc. In addition, the quantum computing platform 1110 comprises a hardware architecture of processors, memory, etc., which is configured to control the execution of quantum applications, and interface with the control system 1120 to (i) generate digital control signals that are converted to analog microwave control signals by the control system 1120, to control operations of the quantum processor 1130 when executing a given quantum application, and (ii) to obtain and process digital signals received from the control system 1120, which represent the processing results generated by the quantum processor 1130 when executing various gate operations for a given quantum application. In some exemplary embodiments, the quantum computing platform 1110 of the quantum computing system 1100 may be implemented using any suitable computing system architecture (e.g., as shown in FIG. 10) which is configured to implement methods to support quantum computing operations by executing computer readable program instructions that are embodied on a computer program product which includes a computer readable storage medium (or media) having such computer readable program instructions thereon for causing a processor to perform control methods as discussed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

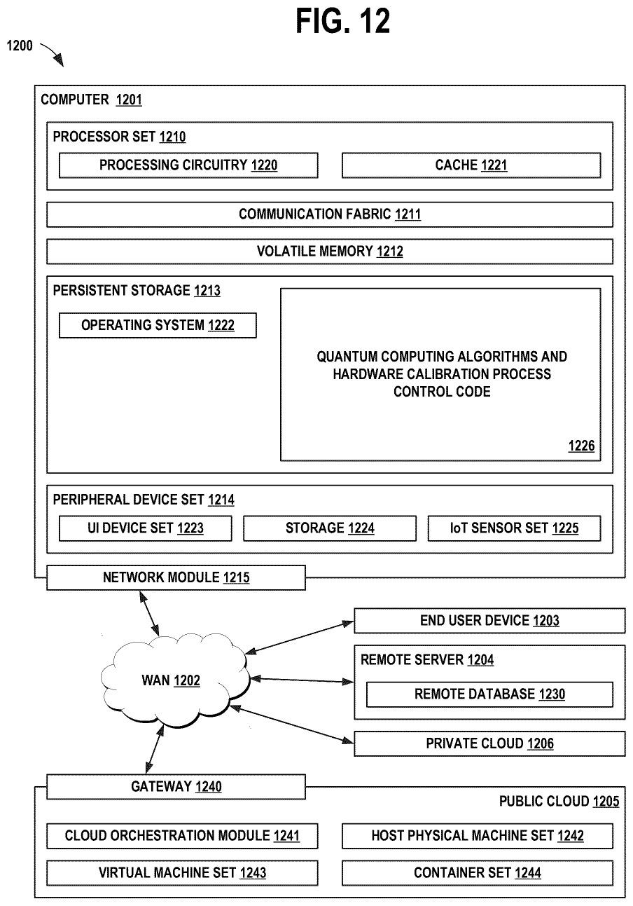

FIG. 12 schematically illustrates an exemplary computing environment 1200 which is configured to execute program instructions for performing quantum computing operations and harmonic distortion calibration operations, according to an exemplary embodiment of the disclosure. The computing environment 1200 contains an example of an environment for the execution of at least some of the computer code 1226 involved in performing inventive methods, such as quantum computing algorithm code to perform quantum computing or quantum information processing, and hardware calibration process control code to control calibration functions of, e.g., the calibration control system 190 of FIG. 1, and the calibration circuitry 1090-1, . . . , 1090-c of FIG. 10, etc. In addition to block 1226, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1226, as identified above), peripheral device set 1214 (including user interface (UI), device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

Computer 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible. Computer 1201 may be located in a cloud, even though it is not shown in a cloud in FIG. 12. On the other hand, computer 1201 is not required to be in a cloud except to any extent as may be affirmatively indicated.

Processor set 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1226 in persistent storage 1213.

Communication fabric 1211 is the signal conduction paths that allow the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 1212 is any type of volatile memory now known or to be developed in the future. Examples include dynamic type random access memory (RAM) or static type RAM. Typically, the volatile memory is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

Persistent storage 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface type operating systems that employ a kernel. The code included in block 1226 typically includes at least some of the computer code involved in performing the inventive methods.

Peripheral device set 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. IoT sensor set 1225 is made up of sensors that can be used in Internet of Things applications. For example, one sensor may be a thermometer and another sensor may be a motion detector.

Network module 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 arc performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

Remote server 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

Public cloud 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device, comprising:
a radio frequency signal generator which comprises:
a plurality of signal paths; and
a signal combiner;
wherein the plurality of signal paths are configured to operate in parallel to convert a baseband signal to a plurality of radio frequency signals, wherein each signal path of the plurality of signal paths outputs a respective one of the plurality of radio frequency signals; and
wherein the signal combiner is configured to combine the plurality of radio frequency signals to cancel corresponding distortion components in the plurality of radio frequency signals, and output a resulting radio frequency output signal with at least one suppressed distortion component.

2. The device of claim 1, wherein:
the plurality of signal paths comprises a first signal path and a second signal path;
the first signal path converts the baseband signal to a first radio frequency signal;
the second signal path converts the baseband signal to a second radio frequency signal;
the corresponding distortion components in the first radio frequency signal and the second radio frequency signal comprise at least one odd-order harmonic component of a baseband frequency of the baseband signal, which is present in both the first radio frequency signal and the second radio frequency signal.

3. The device of claim 2, wherein each signal path of the plurality of signal paths comprises a baseband input stage, a mixer stage coupled to an output of the baseband input stage, and a gain adjust stage coupled to an output of the mixer stage.

4. The device of claim 3, wherein:
the baseband input stage of the first signal path is configured to have a first type of nonlinearity, and
the baseband input stage of the second signal path is configured to have a second type of nonlinearity, which is different from the first type of nonlinearity.

5. The device of claim 4, wherein:
the first type of nonlinearity comprises expansive nonlinearity; and
the second type of nonlinearity comprises compressive nonlinearity.

6. The device of claim 3, wherein
the baseband input stage of the first signal path and the baseband input stage of the second signal path are each configured to have a same type of nonlinearity; and
the same type of nonlinearity comprises a compressive nonlinearity or an expansive nonlinearity.

7. The device of claim 2, wherein:
the first signal path is configured to operate with a first current density;
the second signal path is configured to operate with a second current density, which is less than the first current density; and
the first current density and the second current density are calibrated so that the corresponding distortion components in the first radio frequency signal and the second radio frequency signal have a same signal level.

8. The device of claim 2, wherein the second signal path is configured to operate with phase delay to cause a phase alignment of the corresponding distortion components in the first radio frequency signal and the second radio frequency signal.

9. The device of claim 8, further comprising a phase adjustment circuit which is configured to apply a phase delay to a local oscillator signal that is applied to a mixer stage in the second signal path to cause the phase delay.

10. The device of claim 2, wherein:
the plurality of signal paths further comprise a third signal path to convert the baseband signal to a third radio frequency signal which is output from the third signal path; and
the corresponding distortion components in the first radio frequency signal, the second radio frequency signal, and the third radio frequency signal each comprise at least two odd-order harmonic components of the baseband frequency of the baseband signal; and
the signal combiner is configured to combine the first radio frequency signal, the second radio frequency signal, and the third radio frequency signal to cancel corresponding odd-order harmonic components of a baseband signal frequency, which are present in the first radio frequency signal, the second radio frequency signal, and the third radio frequency signal, and output the resulting radio frequency output signal with at least two suppressed odd-order harmonic components.

11. A system, comprising:
a quantum processor comprising at least one quantum bit;
an arbitrary waveform generator comprising at least one arbitrary waveform generator channel configured to convert a baseband signal to a radio frequency control signal which controls the at least one quantum bit, wherein the at least one arbitrary waveform generator channel comprises:
a plurality of signal paths; and
a signal combiner;
wherein the plurality of signal paths are configured to operate in parallel to convert the baseband signal to a plurality of radio frequency signals, wherein each signal path of the plurality of signal paths outputs a respective one of the plurality of radio frequency signals; and
wherein the signal combiner is configured to combine the plurality of radio frequency signals to cancel corresponding distortion components in the plurality of radio frequency signals, and output a resulting radio frequency output signal as the radio frequency control signal, which comprises at least one suppressed distortion component.

12. The system of claim 11, wherein:
the plurality of signal paths comprises a first signal path and a second signal path;
the first signal path converts the baseband signal to a first radio frequency signal;
the second signal path converts the baseband signal to a second radio frequency signal;
the corresponding distortion components in the first radio frequency signal and the second radio frequency signal comprise at least one odd-order harmonic component of a baseband frequency of the baseband signal, which is present in both the first radio frequency signal and the second radio frequency signal.

13. The system of claim 12, wherein each signal path of the plurality of signal paths comprises a baseband input stage, a mixer stage coupled to an output of the baseband input stage, and a gain adjust stage coupled to an output of the mixer stage.

14. The system of claim 13, wherein:
the baseband input stage of the first signal path is configured to have a first type of nonlinearity, and
the baseband input stage of the second signal path is configured to have a second type of nonlinearity, which is different from the first type of nonlinearity.

15. The system of claim 14, wherein:
the first type of nonlinearity comprises expansive nonlinearity; and
the second type of nonlinearity comprises compressive nonlinearity.

16. The system of claim 14, wherein
the baseband input stage of the first signal path and the baseband input stage of the second signal path are each configured to have a same type of nonlinearity; and
the same type of nonlinearity comprises a compressive nonlinearity or an expansive nonlinearity.

17. The system of claim 12, wherein:
the first signal path is configured to operate with a first current density;
the second signal path is configured to operate with a second current density, which is less than the first current density; and
the first current density and the second current density are calibrated so that the corresponding distortion components in the first radio frequency signal and the second radio frequency signal have a same signal level.

18. The system of claim 12, wherein the second signal path is configured to operate with phase delay to cause a phase alignment of the corresponding distortion components in the first radio frequency signal and the second radio frequency signal.

19. A device, comprising:
a radio frequency signal generator which comprises:
a first signal path;
a second signal path; and
a signal combiner;
wherein the first signal path and the second signal path are configured to operate in parallel to convert a baseband signal to a first radio frequency signal which is output from the first signal path, and a second radio frequency signal which is output from the second signal path; and
wherein the signal combiner is configured to combine the first radio frequency signal and the second radio frequency signal to cancel corresponding third-order harmonic frequency components of a baseband signal frequency in the first radio frequency signal and the second radio frequency signal, and output a resulting radio frequency output signal in which the third-order harmonic frequency components of the baseband signal frequency is substantially suppressed.

20. The device of claim 19, wherein:
the radio frequency signal generator further comprises a third signal path, which is configured to operate in parallel with the first signal path and the second signal path, to convert the baseband signal to a third radio frequency signal which is output from the third signal path; and
the signal combiner is configured to combine the first radio frequency signal, the second radio frequency signal, and the third radio frequency signal to cancel the corresponding third-order harmonic frequency components of the baseband signal frequency and corresponding fifth-order harmonic frequency components of the baseband signal frequency, which are present in the first radio frequency signal, the second radio frequency signal, and the third radio frequency signal, and output a resulting radio frequency output signal in which the third-order harmonic frequency component and the fifth-order harmonic frequency component are substantially suppressed.

21. A method, comprising:
converting a baseband signal to a radio frequency signal using a plurality of signal paths which operate in parallel to convert the baseband signal to a plurality of radio frequency signals, wherein each signal path of the plurality of signal paths outputs a respective one of the plurality of radio frequency signals; and
combining the plurality of radio frequency signals to cancel corresponding distortion components in the plurality of radio frequency signals, and output a resulting radio frequency output signal with at least one suppressed distortion component.

22. The method of claim 21, comprising:
configuring a first signal path of the plurality of signal paths to operate with a first current density and output a first radio frequency signal of the plurality of radio frequency signals; and
configuring a second signal path of the plurality of signal paths to operate with a second current density, which is less than the first current density, and output a second radio frequency signal of the plurality of radio frequency signals;
wherein the first current density and the second current density are calibrated so that the corresponding distortion components in the first radio frequency signal and the second radio frequency signal have a same signal level.

23. The method of claim 22, further comprising configuring the second signal path to operate with phase delay to cause a phase alignment of the corresponding distortion components in the first radio frequency signal and the second radio frequency signal.

24. A method, comprising:
calibrating a radio frequency signal generator to convert a baseband signal to a radio frequency control signal, wherein calibrating the radio frequency signal generator comprises:
calibrating a first signal path of the radio frequency signal generator to operate with a first current density;
operating the first signal path to convert the baseband signal to a first radio frequency signal;
analyzing the first radio frequency signal to determine a signal level of a target harmonic component in the first radio frequency signal;
calibrating a second signal path of the radio frequency signal generator to operate with a second current density, which is less than the first current density;
operating the second signal path to convert the baseband signal to a second radio frequency signal;
analyzing the second radio frequency signal to determine a signal level of the target harmonic component in the second radio frequency signal;
determining a difference between the signal levels of the target harmonic components in the first radio frequency signal and the second radio frequency signal; and
in response to determining that the difference between the signal levels of the target harmonic components in the first radio frequency signal and the second radio frequency signal exceeds a specified threshold, recalibrating a second signal path of the radio frequency signal generator to adjust the second current density to equalize signal levels of the target harmonic components in the first radio frequency signal and the second radio frequency signal.

25. The method of claim 24, wherein:
calibrating the first signal path of the radio frequency signal generator to operate with the first current density comprises calibrating the first current density to achieve a target signal level of a fundamental frequency component in the first radio frequency signal;
calibrating the first signal path comprises adjusting a gain setting of a baseband input stage in the first signal path to set the first current density in the first signal path; and
calibrating the second signal path comprises adjusting a gain setting of a baseband input stage in the second signal path to set the second current density in the second signal path.
